(19) United States
(12) Patent Application Publication
(10) Pub. No.: US 2026/0304413 A1
(43) Pub. Date: Oct. 1, 2026

(54) INTRA-CLUSTER TRANSMISSION POWER ASSOCIATED WITH A CLUSTER OF ELECTRONIC SHELF LABELS

(71) Applicant: QUALCOMM Incorporated, San Diego, CA (US)

(72) Inventors: Varun Amar REDDY, San Diego, CA (US); Amit GOEL, San Diego, CA (US); Chengjin ZHANG, San Diego, CA (US)

(21) Appl. No.: 19/410,759

(22) Filed: Dec. 5, 2025

Related U.S. Application Data
(60) Provisional application No. 63/777,907, filed on Mar. 26, 2025.

(51) Int. Cl. H04W 72/044; H04W 24/10; H04W 52/18

(52) U.S. Cl. CPC H04W 72/0473; H04W 24/10; H04W 52/18

(57) ABSTRACT

Aspects are directed to intra-cluster transmission power associated with a cluster of electronic shelf labels (ESLs). In an aspect, an ESL controller determines a signaling configuration associated with intra-cluster signaling operation between ESLs of a cluster of ESLs deployed in a facility. In an aspect, the signaling configuration comprises a time-frequency (T-F) resource configuration, and a transmission power configuration that configures intra-cluster transmission power based on distances between respective ESLs of the cluster of ESLs and a designated ESL (i.e., cluster head) of the first cluster of ESLs. In an aspect, the ESL controller transmits the signaling configuration to the cluster of ESLs. The ESL(s) perform an intra-cluster signaling operation in accordance with the signaling configuration an intra-cluster signaling operation in accordance with the signaling configuration. Such aspects may provide various technical advantages, such as interference mitigation, improved ESL cluster scheduling, and so on.

### CROSS-REFERENCE TO RELATED APPLICATIONS

The present Application for Patent claims the benefit of U.S. Provisional Application No. 63/777,907, entitled “INTRA-CLUSTER TRANSMISSION POWER ASSOCIATED WITH A CLUSTER OF ELECTRONIC SHELF LABELS,” filed Mar. 26, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method performed by an electronic shelf label (ESL) controller includes determining a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmitting the first signaling configuration to the first cluster of ESLs.

In an aspect, a method performed by an electronic shelf label (ESL) includes receiving, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and performing an intra-cluster signaling operation in accordance with the signaling configuration.

In an aspect, an electronic shelf label (ESL) controller includes one or more memories; one or more transceivers; and one or more processors communicatively coupled to the one or more memories and the one or more transceivers, wherein the one or more processors, either alone or in combination, are configured to: determine a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmit, via the one or more transceivers, the first signaling configuration to the first cluster of ESLs.

In an aspect, an electronic shelf label (ESL) includes one or more memories; one or more transceivers; and one or more processors communicatively coupled to the one or more memories and the one or more transceivers, wherein the one or more processors, either alone or in combination, are configured to: receive, via the one or more transceivers, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and perform an intra-cluster signaling operation in accordance with the signaling configuration.

In an aspect, an electronic shelf label (ESL) controller includes means for determining a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and means for transmitting the first signaling configuration to the first cluster of ESLs.

In an aspect, an electronic shelf label (ESL) includes means for receiving, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and means for performing an intra-cluster signaling operation in accordance with the signaling configuration.

In an aspect, a non-transitory computer-readable medium storing computer-executable instructions that, when executed by an electronic shelf label (ESL) controller, cause the ESL controller to: determine a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmit the first signaling configuration to the first cluster of ESLs.

In an aspect, a non-transitory computer-readable medium storing computer-executable instructions that, when executed by an electronic shelf label (ESL) controller, cause the ESL controller to: receive, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and perform an intra-cluster signaling operation in accordance with the signaling configuration.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic shelf label (ESL) system, according to aspects of the disclosure.

FIG. 2 illustrates example components of an example ESL, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example electronic shelf label (ESL) deployment scenario, according to aspects of the disclosure.

FIG. 5 is a diagram illustrating an example positioning scenario using a weighted centroid algorithm, according to aspects of the disclosure.

FIG. 6 illustrates an example electronic tag, according to aspects of the disclosure.

FIG. 7 illustrates an example neural network, according to aspects of the disclosure.

FIG. 8A is a diagram illustrating an example of direct artificial intelligence/machine learning (AIML) positioning and/or sensing, according to aspects of the disclosure.

FIG. 8B is a diagram illustrating an example of AIML assisted positioning and/or sensing, according to aspects of the disclosure.

FIG. 8C illustrates various AIML positioning and/or sensing scenarios, according to aspects of the disclosure.

FIG. 9 illustrates an ELS deployment scenario, in accordance with an aspect of the disclosure.

FIG. 10 illustrates Bluetooth Low Energy (BLE) Generic Attribute Profile (GATT) procedure, in accordance with aspects of the disclosure.

FIG. 11 illustrates ESL Periodic Advertising with Responses (PAWR) scheme, in accordance with aspects of the disclosure.

FIG. 12 illustrates an exemplary process of communications according to an aspect of the disclosure.

FIG. 13 illustrates an exemplary process of communications according to an aspect of the disclosure.

FIG. 14 illustrates an exemplary process of communications according to an aspect of the disclosure.

FIG. 15 illustrates an example implementation of the processes of FIGS. 12-14 of processes, respectively, in accordance with aspects of the disclosure.

FIG. 16 illustrates an example implementation of the processes of FIGS. 12-14 of processes, respectively, in accordance with aspects of the disclosure.

FIG. 17 illustrates an example implementation of the processes of FIGS. 12-14 of processes, respectively, in accordance with aspects of the disclosure.

FIG. 18 illustrates an example implementation of the processes of FIGS. 12-14 of processes, respectively, in accordance with aspects of the disclosure.

FIG. 19 illustrates an example implementation of the processes of FIGS. 12-14 of processes, respectively, in accordance with aspects of the disclosure.

FIG. 20 illustrates an example implementation of the processes of FIGS. 12-14 of processes, respectively, in accordance with aspects of the disclosure.

FIG. 21 illustrates Bluetooth channel configuration 2100, in accordance with aspects of the disclosure.

FIG. 22 illustrates an example implementation of the processes of FIGS. 19-20 of processes, respectively, in accordance with aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Aspects are directed to intra-cluster transmission power associated with a cluster of electronic shelf labels (ESLs). In an aspect, an ESL controller determines a signaling configuration associated with intra-cluster signaling operation between ESLs of a cluster of ESLs deployed in a facility. In an aspect, the signaling configuration comprises a time-frequency (T-F) resource configuration, and a transmission power configuration that configures intra-cluster transmission power based on distances between respective ESLs of the cluster of ESLs and a designated ESL (i.e., cluster head) of the first cluster of ESLs. In an aspect, the ESL controller transmits the signaling configuration to the cluster of ESLs. The ESL(s) perform an intra-cluster signaling operation in accordance with the signaling configuration an intra-cluster signaling operation in accordance with the signaling configuration. Such aspects may provide various technical advantages, such as interference mitigation, improved ESL cluster scheduling, and so on.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image, thereby significantly reducing power consumption.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

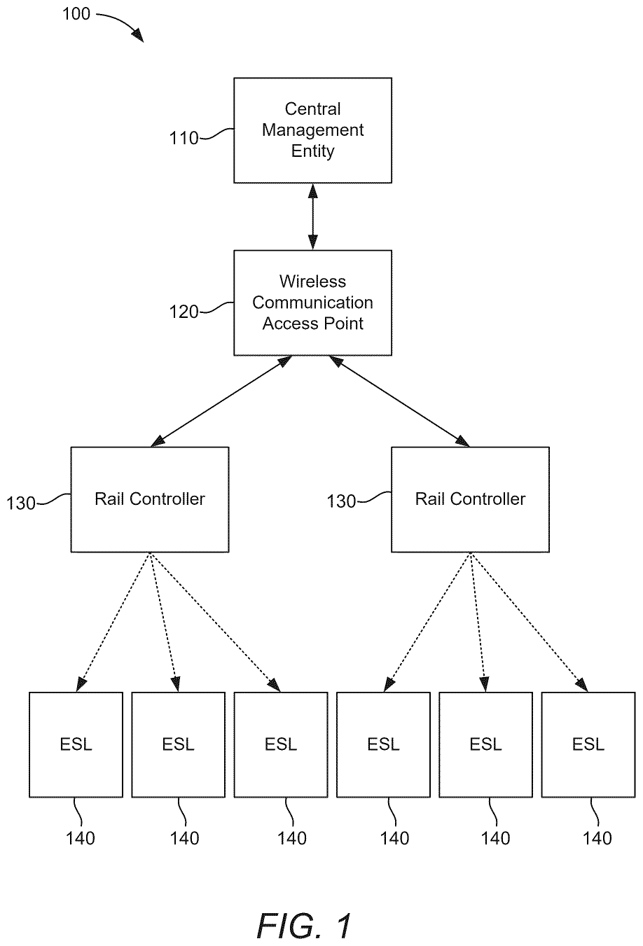

FIG. 1 illustrates an example ESL system 100, according to aspects of the disclosure. An ESL system generally includes three components: label management software (e.g., running on a central management entity 110, such as a local server at the retail location or a cloud-based server), one or more wireless communication access points 120 (e.g., Wi-Fi access points), one or more rail controllers 130, and one or more (usually many) ESLs 140. The label management software is responsible for the configuration of the system, configuration of the properties of the ESLs 140 themselves, and storing the database of information to be displayed by the ESLs 140. The software mainly covers the network management, file systems, and transmission of data. It also processes and packs the data to be displayed into packets of information. The data packets are then sent to one or more wireless communication access points 120 via a wireless network (e.g., Wi-Fi) for distribution to the ESLs 140 via the one or more rail controllers 130.

A wireless communication access point 120 is responsible for the stability and reliability of transmissions from the label management software (on the central management entity 110) to the ESLs 140. There may be multiple wireless communication access points 120 deployed in a single retail location based on the size of the space and/or the number of ESLs 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple ESLs 140 can be “clipped” or otherwise attached. Once clipped to the rail, each ESL 140 has a wired connection to the rail controller 130 (e.g., via a three-wire bus for power, ground, and data).

An ESL 140 functions as a receiver from the wireless communication access point 120 (via the rail controller 130) to display the information configured from the label management software. The ESL 140 then acts based on the instructions that were provided in the data packets from the label management software. An ESL 140 includes a display and optionally a camera. ESLs 140 generally do not include batteries, as they are typically powered by the rail to which they are attached. However, in some cases, an ESL 140 may be powered by a coin-cell battery, which may provide an operational life of eight to nine years. In some cases, an ESL 140 may not have a short-range wireless communications radio (e.g., a BLE radio), as it receives data from the wireless communication access point 120 via the wired rail connection to the rail controller 130.

An ESL application programming interface (API) is included in the current BLUETOOTH® specification and permits a 7-bit group identifier of 8-bit unique ESL identifiers, allowing for a total of 32,640 ESLs 140 to be allocated for one wireless communication access point 120. With those constraints, multiple wireless communication access points 120 may be needed to cover a typical grocery store ESL application.

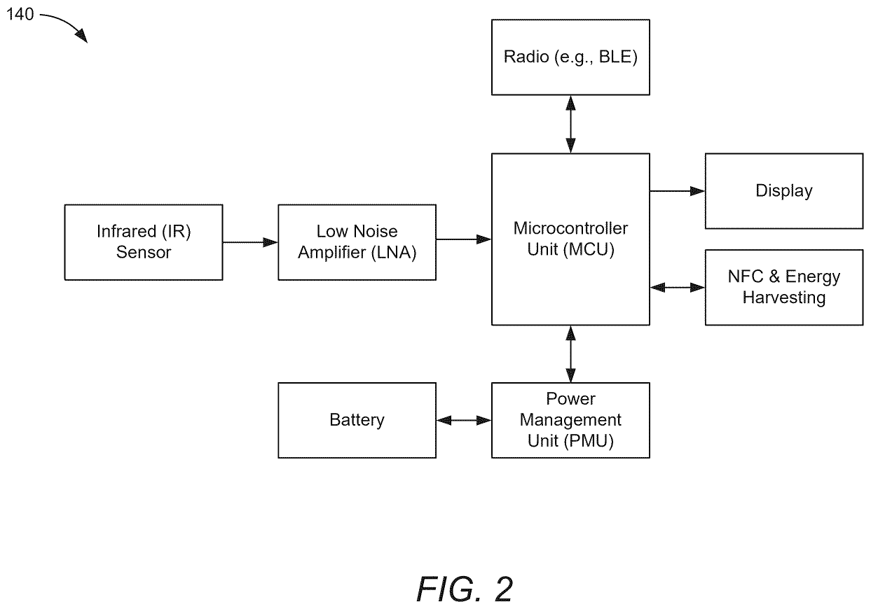

FIG. 2 illustrates example components of an example ESL 140, according to aspects of the disclosure. Note that in some cases, rather than an ESL 140 having its own wireless radio (e.g., a BLE radio) as shown in FIG. 2, multiple ESLs 140 may be attached (e.g., clipped) to a rail attached to a retail shelf. In this case, the rail (specifically a rail controller 130) contains the short-range wireless communications radio and the ESLs 140 have just the display. The radio controller 130 in the rail communicates locally to the clipped-on ESLs 140 over a wired protocol (the act of clipping on connects the ESLs 140 to the wires of the rail controller 130). As such, an ESL 140 itself may not have a radio but may connect locally to one (i.e., the rail controller 130).

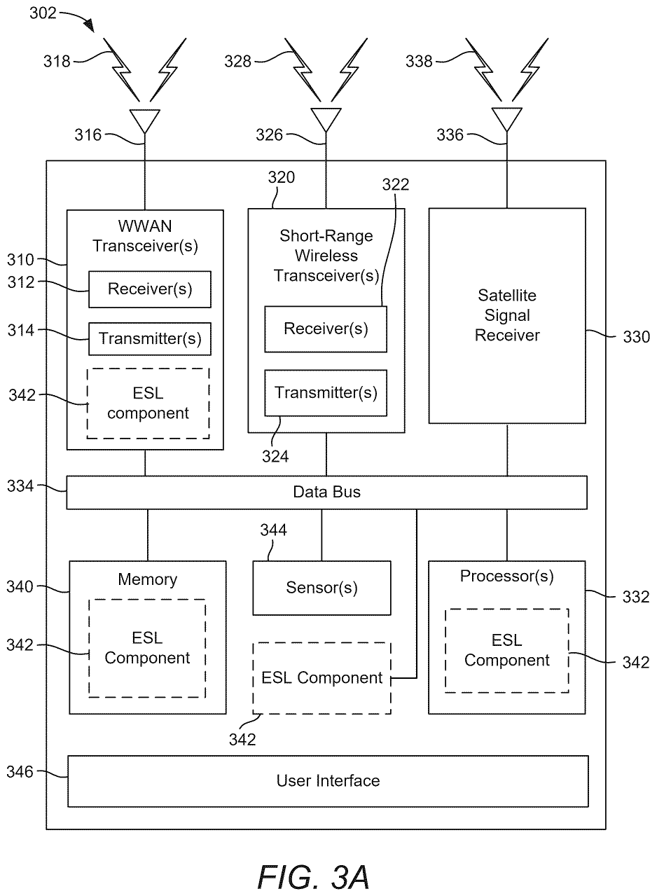

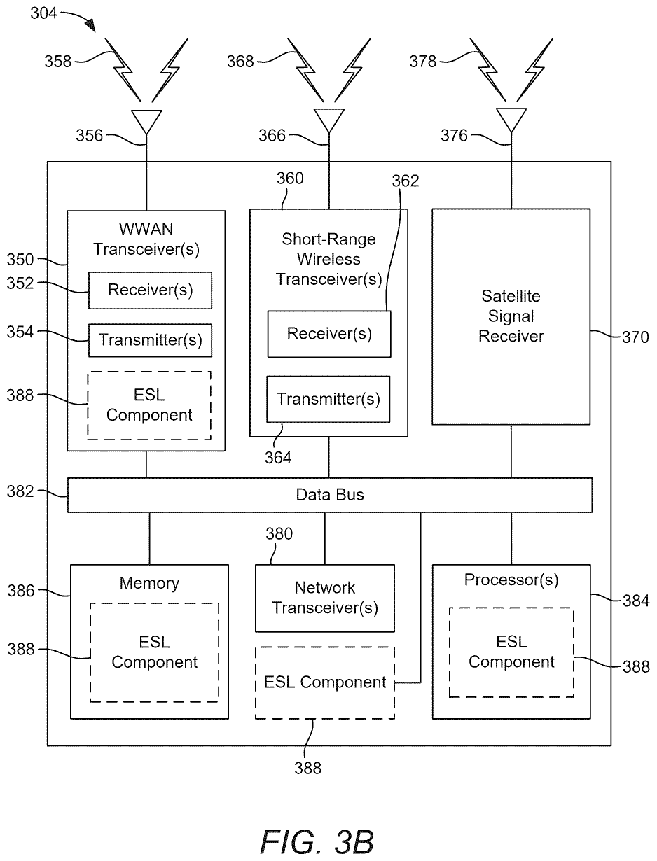

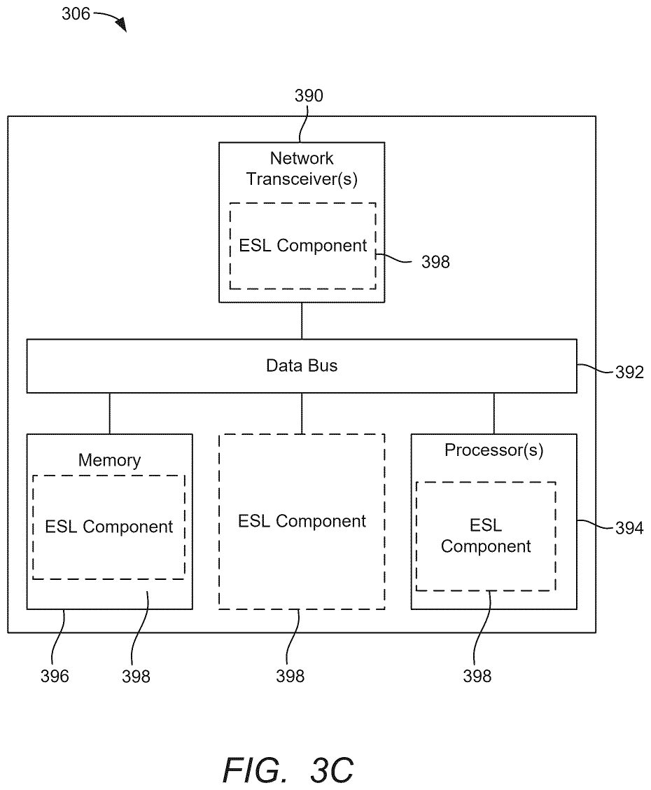

FIGS. 3A, 3B, and 3C illustrate several example components (represented by corresponding blocks) that may be incorporated into a UE 302 (which may correspond to any of the UEs described herein), a base station 304 (which may correspond to any of the base stations or access points described herein), and a network entity 306 to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a Global System for Mobile Communications (GSM) network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVER transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS®) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include ESL component 342, 388, and 398, respectively. The ESL component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the ESL component 342, 388, and 398 may be external to the processors 332, 384, and 394 (e.g., part of a modem processing system, integrated with another processing system, etc.). Alternatively, the ESL component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the ESL component 342, which may be, for example, part of the one or more WWAN transceivers 310, the memory 340, the one or more processors 332, or any combination thereof, or may be a standalone component. FIG. 3B illustrates possible locations of the ESL component 388, which may be, for example, part of the one or more WWAN transceivers 350, the memory 386, the one or more processors 384, or any combination thereof, or may be a standalone component. FIG. 3C illustrates possible locations of the ESL component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to assist in the computation of positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for a radio resource control (RRC) layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and multiple input-multiple output (MIMO) antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate a radio frequency (RF) carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the ESL component 342, 388, and 398, etc.

In some designs, the network entity 306 may be implemented as a core network component. In other designs, the network entity 306 may be distinct from a network operator or operation of the cellular network infrastructure. For example, the network entity 306 may be a component of a private network that may be configured to communicate with the UE 302 via the base station 304 or independently from the base station 304 (e.g., over a non-cellular communication link, such as Wi-Fi).

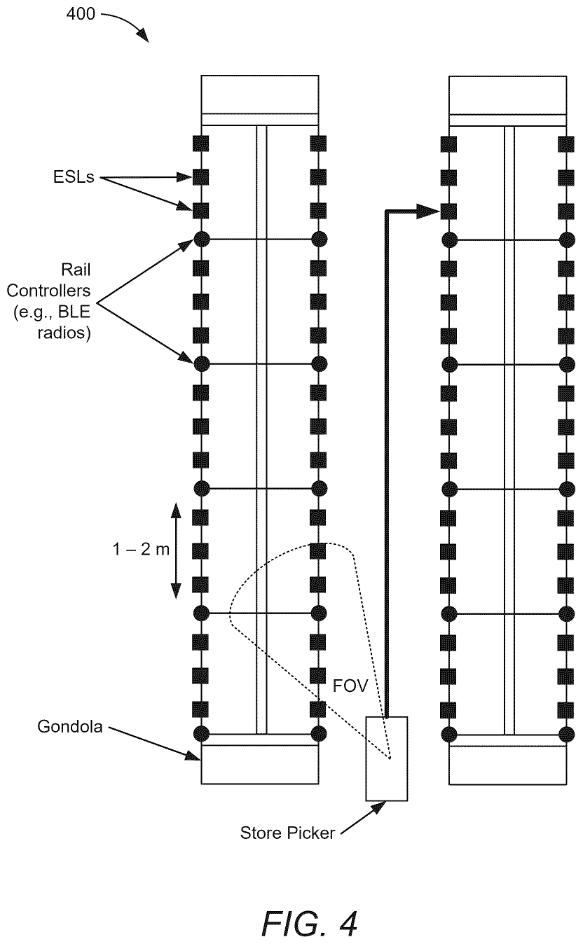

FIG. 4 is a diagram 400 illustrating an example ESL deployment scenario, according to aspects of the disclosure. Specifically, FIG. 4 illustrates a top view of a scenario where ESLs (e.g., ESLs 140) are deployed on both sides of two aisles of shelves in a retail establishment, warehouse, or the like. In the example of FIG. 4, groups of three ESLs are connected to a rail controller (e.g., a radio controller 130 utilizing, for example, a BLE radio) and the rail controllers are spaced 1 m to 2 m apart. However, as will be appreciated, this is merely an example configuration and there may be more or fewer ESLs per rail controller spaced closer or further apart.

In some cases, the ESLs may not be equipped with short-range wireless communications radios (e.g., BLE radios), and instead, the rail controller may include the short-range wireless communications radio for the three ESLs connected to it. In either case, the radio associated with an ESL (whether a component of the ESL of the rail controller to which the ESL is connected) may be referred to as an “ESL radio.”

Indoor positioning based on BLE beaconing from ESLs is being developed for retail and warehouse applications. In general, the location of a target device (e.g., an electronic tag (eTag)) is determined based on signal strength measurements (e.g., received signal strength indicator (RSSI)) of beacon signals transmitted by multiple ESLs. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

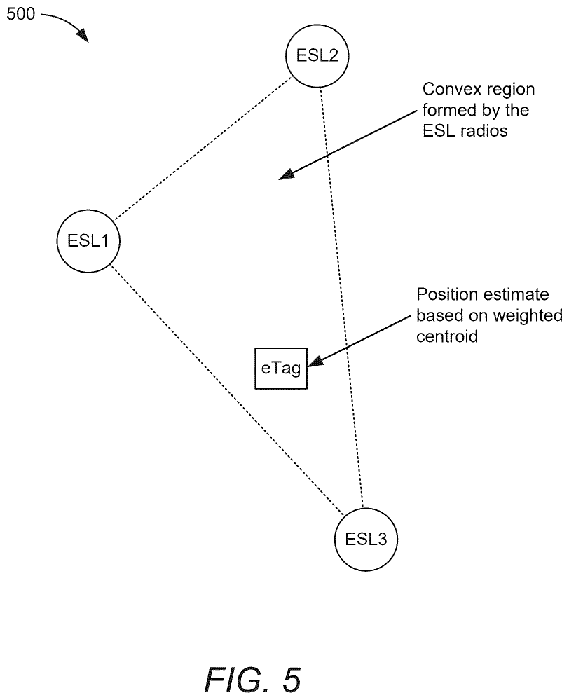

FIG. 5 is a diagram 500 illustrating an example positioning scenario using a weighted centroid algorithm, according to aspects of the disclosure. In the example of FIG. 5, measurements of the beacon signals transmitted by three ESL radios (labeled “ESL1,” “ESL2,” and “ESL3”) are used to determine a location of a target device (labeled “eTag”). For a given target device beacon transmission, let r₁≥r₂≥ . . . r_{M} denote the RSSI values of the beacon as measured by M ESL radios (in descending order). The target device position estimate is then given by the weighted average of the ESL radio positions, where the weights are a function of the RSSI values:

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of ESL radios that are used in the computation, and wₖ is an exponential function (based on a value λ) of the RSSI values. N and λ are empirical terms that may be preset to some desired value. The weights may be proportional to the RSSIs. That is, the weight assigned to the k^{th} ESL radio is proportional to the signal strength measured by that ESL radio, meaning an ESL radio associated with a higher RSSI may be assigned a larger weight. In the example of FIG. 5, w₃>w₁>w₂.

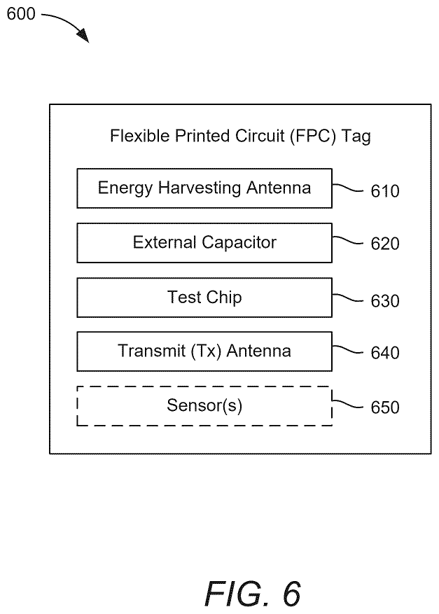

Low-cost flexible electronic “tags” (referred to as “eTags”) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi, NR). For example, the test chip 630 and transmit antenna 640 may act as a BLE beacon and support BLE advertisement transmission. Note that in some cases, the transmit antenna 640 may also act as an energy harvesting antenna.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby ESL radios (e.g., ESL1, ESL2, and ESL3). The ESL radios may report their RSSI measurements to the central management entity 110, which may calculate the position of the eTag 600 or forward the measurements to another entity for processing.

In some cases, eTags may be utilized in an ESL deployment scenario, such as illustrated in FIG. 4. For example, eTags may be attached to the boxes, pallets, or other containers holding individual products, or may be attached to the individual products themselves. In such a scenario, an eTag subsystem coexists with the ESL subsystem (e.g., the central management entity 110, the wireless communication access point 120, the rail controllers 130, and the ESLs 140). The eTag subsystem includes the eTags, multiple energizer devices deployed within the environment to power the eTags, and a gateway or edge server connected to the energizer devices.

The gateway or edge server may be shared with the ESL subsystem (e.g., it may be a central management entity 110) and may perform joint management of the ESL and eTag subsystems. For example, the gateway or edge server may pair energizer devices to access points (e.g., wireless communication access points 120) for timing synchronization across the subsystems.

The energizer devices may operate in, for example, the 900 MHz and/or 2.4 GHz range(s), depending on the energy harvesting and beacon transmission configuration of the eTags. In some cases, therefore, the energizer devices may be dual mode, meaning they can operate as RFID readers to energize the eTags and BLE devices to receive/measure the BLE beacons transmitted by the eTags. (Note, however, that as described above, the energizer devices may be located further from the eTags than they would need to be from any RFID tags.) The energizer devices may also coordinate timing synchronization between the ESL radios and the eTags. Note that in a joint ESL and eTag deployment, the ESL radios do not energize the eTags; they only receive/measure the beacon transmissions from the eTags.

As described above with reference to FIG. 5, ESL radio infrastructure can be used for position estimation, as they present a highly dense network of anchor nodes that can achieve sub-meter accuracy in retail and warehouse settings.

With respect to UE interaction with the gateway or edge server (referred to simply as a “server” for simplicity), the server may send indications/requests to one or more UEs to scan for eTag beacons and report any received data. In some cases, the server may provide a list of eTag MAC identifiers for which the UE(s) should scan, and request the UE(s) to relay any payloads matching the eTag MAC identifiers. In some cases, if a UE can decode a payload, the server may indicate to the UE to relay payloads or payload information that satisfies certain criteria (e.g., a temperature reading above 0 degrees, a weight above 100 pounds, etc.).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server, which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

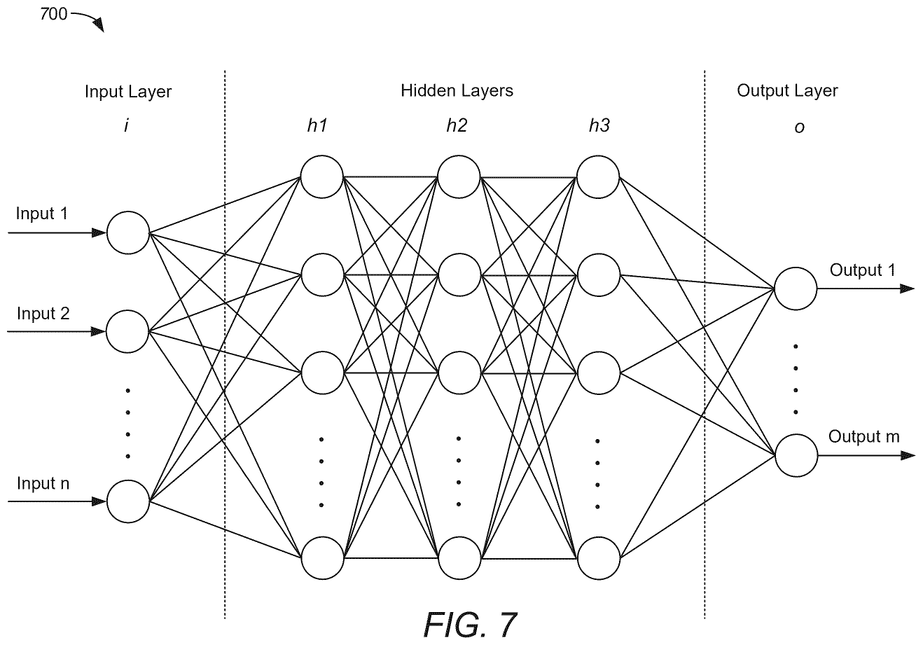

FIG. 7 illustrates an example neural network 700, according to aspects of the disclosure. The neural network 700 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system, such as processors 332, 384, or 394) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

The artificial intelligence/machine learning (AIML) positioning and/or sensing provided by an AIML model may be “direct” AIML (denoted “D-AIML”) positioning and/or sensing or AIML “assisted” (denoted “A-AIML”) positioning and/or sensing. Note that, as used herein, an AIML model (whether an A-AIML model or a D-AIML model) may alternatively be referred to as an “ML model,” an “AI model,” an “ML-based model,” an “AI-based model,” and the like.

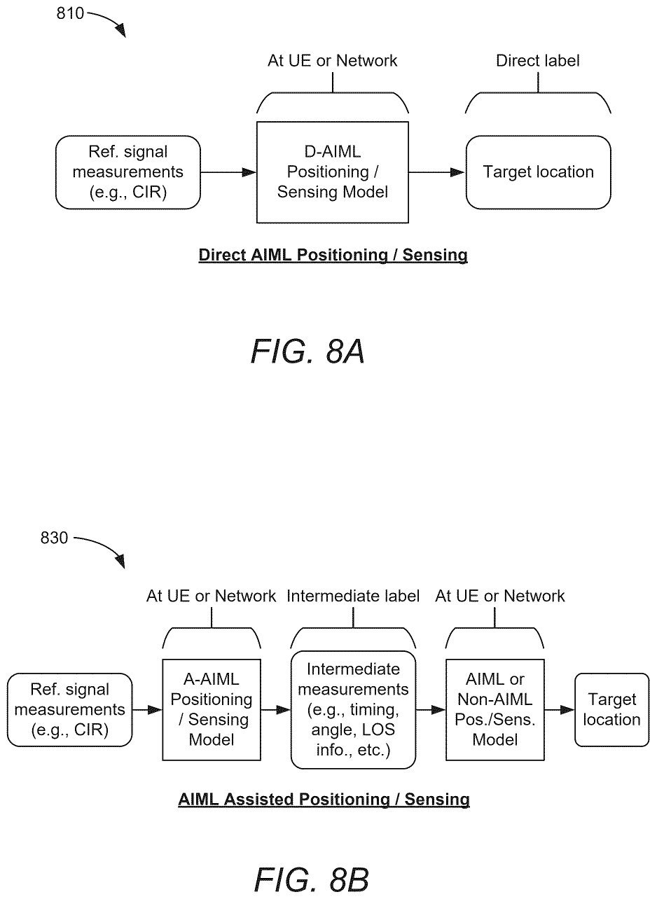

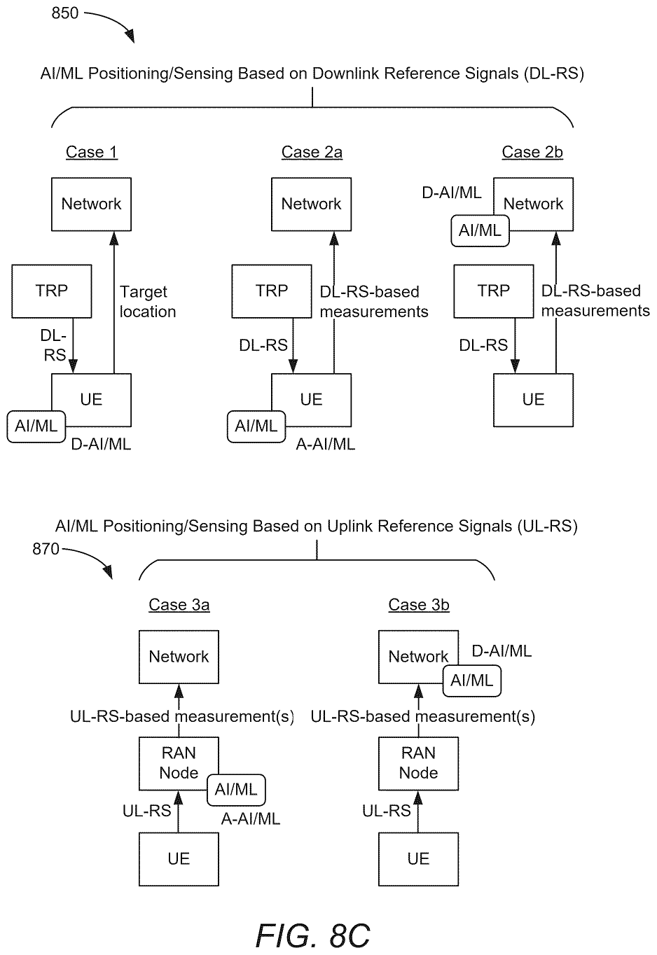

FIG. 8A is a diagram 810 illustrating an example of direct AIML positioning and/or sensing, according to aspects of the disclosure. As shown in FIG. 8A, direct AIML positioning and/or sensing is where the AIML model is trained to accept input features (e.g., downlink positioning reference signal (DL-PRS) measurements, sounding reference signal (SRS) measurements, sidelink positioning reference signal (SL-PRS) measurements, sensing signal measurements, beam measurements (e.g., synchronization signal block (SSB) measurements), channel state information reference signal (CSI-RS) measurements, etc.) and output a final result (referred to as a “direct label”), such as a target location (e.g., a UE location for positioning or a target object location for sensing). The measurements of the reference signal(s) may include the channel energy response (CER), channel impulse response (CIR), power delay profile (PDP), delay profile (DP), channel frequency response (CFR), received signal strength indicator (RSSI), reference signal received power (RSRP), path RSRP (RSRPP), reference signal received quality (RSRQ), time of arrival (ToA), relative ToA (RTOA), reference signal time difference (RSTD), angle of departure (AoD), angle of arrival (AoA), and/or the like of the reference signal(s).

FIG. 8B is a diagram 830 illustrating an example of AIML assisted positioning and/or sensing, according to aspects of the disclosure. As shown in FIG. 8B, AIML assisted positioning and/or sensing is where an AIML model is trained to accept input features (e.g., DL-PRS measurements, SRS measurements, SL-PRS measurements, sensing signal measurements, beam measurements, CSI-RS measurements, etc.) and output one or more intermediate results (also referred to as “intermediate label(s)”). In a positioning context, generating the intermediate result may be referred to as “positioning feature extraction,” which may include determining timing/angle information, line of sight (LOS) identification, etc. The intermediate results may include the ToA, RTOA, RSTD, AOD, AoA, LOS indication, and/or the like. The intermediate result(s) may in turn be provided as an input to another AIML model or non-AIML model positioning and/or sensing technique (e.g., Chan's algorithm, Kalman filtering, etc.) to determine a target location (e.g., a UE location for positioning or a target object location for sensing).

Note that as shown in FIG. 8B, the A-AIML model and the other model/technique may be implemented at the same entity (e.g., UE, base station, location server, sensing server, etc.) or at different entities. For example, for network-assisted positioning, the UE may apply the A-AIML model to compress the measurement data and then report the compressed data to the location server, which may then apply the other position estimation model/technique. As another example, for UE-based positioning, a network component (e.g., a base station, location server, or another UE for sidelink positioning) may apply the A-AIML model to compress the measurement data and report the compressed data to the UE, which then applies the other position estimation model/technique.

FIG. 8C illustrates various AIML positioning and/or sensing scenarios, according to aspects of the disclosure. As shown in diagram 850, there are three AIML positioning and/or sensing deployment scenarios based on downlink reference signals (e.g., DL-PRS, CSI-RS, etc.). The first deployment scenario (labeled “Case 1”) is a UE-based positioning and/or sensing case with a UE-side D-AIML positioning and/or sensing model (labeled “D-AIML”). In this case, the UE applies the D-AIML positioning and/or sensing model (or simply “D-AIML model”) to the downlink reference signal measurements to determine a location of the UE or a target object and reports the target location to the network.

The second deployment scenario (labeled “Case 2a”) is UE-assisted/network-based positioning and/or sensing with a UE-side A-AIML positioning and/or sensing model that provides AIML-assisted positioning and/or sensing. That is, the UE inputs measurements of downlink reference signals (e.g., DL-PRS, CSI-RS) received from one or more TRPs into the A-AIML positioning and/or sensing model to obtain intermediate measurements (or quantities) of the downlink reference signals. The UE then reports the intermediate measurements to the network. The network entity may then apply an AIML model or a non-AIML model technique to the intermediate measurements to determine a target location (e.g., of the UE for positioning scenarios or a target object for sensing scenarios).

The third deployment scenario (labeled “Case 2b”) is UE-assisted/network-based positioning and/or sensing scenario with a network-side D-AIML positioning and/or sensing model. That is, the UE reports the measurements of the downlink reference signals received from one or more TRPs to the network. The network then applies the D-AIML positioning and/or sensing model to the measurements to determine the location of the UE or a target object.

As shown in diagram 870, there are two AIML positioning and/or sensing deployment scenarios based on uplink reference signals (e.g., SRS). The first deployment scenario (labeled “Case 3a”) is RAN node-assisted positioning and/or sensing with a RAN-side AIML model that provides AIML assisted positioning and/or sensing. In this case, the RAN node (e.g., a base station, TRP, or other base station component) applies an A-AIML positioning and/or sensing model to TRP measurements of one or more uplink reference signals (e.g., SRS) transmitted by a UE to obtain intermediate measurements of the received uplink reference signal(s). The RAN node then reports the intermediate measurements to the core network, which can use them to locate the UE (for positioning) or a target object (for sensing).

The second deployment scenario (labeled “Case 3b”) is RAN node-assisted positioning and/or sensing with a network-side AIML positioning and/or sensing model that provides direct AIML positioning and/or sensing. In this case, the RAN node reports measurements of one or more uplink reference signals received from a UE to the core network. The core network then applies a D-AIML positioning and/or sensing model to the measurements of the uplink reference signal(s) to obtain a target location of the UE (for positioning) or a target object (for sensing).

Note that there may be other deployment scenarios in which the UE, RAN, or the core network use an AIML positioning and/or sensing model to compute or report a positioning and/or sensing estimate (target location), but these cases are implementation-specific and do not necessarily involve signaling between the UE, RAN, and/or the core network.

Further note that an AIML model may execute in a training mode or an inferencing mode. In the training mode, the AIML model is provided with pre-validated input data along with pre-validated output data to derive or modify weights of the AIML to increase the reliability of the AIML model to provide new (unvalidated) output data that is similar to the pre-validated output data in response to new (unvalidated) input data that is similar to the pre-validated input data. In the inferencing mode, the AIML model utilizes the weights determined during the training mode to process new (unvalidated) input data so as to generate new (unvalidated) output data (typically, without further adjusting the weights until/unless the AIML model returns to the training mode). The (unvalidated) output data may be characterized as an “inference.” Thus, the “final” positioning or sensing results described above with respect to FIGS. 8A to 8C may correspond to AIML model weights or inferences depending on whether the respective AIML model is executing in the training mode or the inferencing mode.

In some designs, inferring the locations of the ESL-BLE radios is an essential process for enabling a variety of site-specific proprietary services within a given store as well as third-party promoted over-the-top (OTT) services such as telemarketing (e.g., OTT positioning refers to positioning that is performed outside of the carrier network's LMF). In some designs, an analogue third-party system that provides OTT services includes GOOGLE's indoor positioning system that utilizes crowdsourced Wi-Fi deployments. Similar systems may be considered as ESL technology becomes more widespread.

Another use-case where ESL radio positioning may be utilized is the deployment process itself; e.g., a specific proprietor or store contractor may deploy the system, but not record the actual locations of the radios; in such cases the store itself as a service provider needs to estimate them to provide location-based ESL services.

Unlike Wi-Fi deployments, ESL-BLE deployments may be dense with a large number of short-range radios. In such dense ESL-BLE deployments, “reverse” positioning of ESL radios (i.e., obtaining the ESL locations, rather than using the ESLs for positioning of non-ESL devices) in such circumstances may be a difficult task.

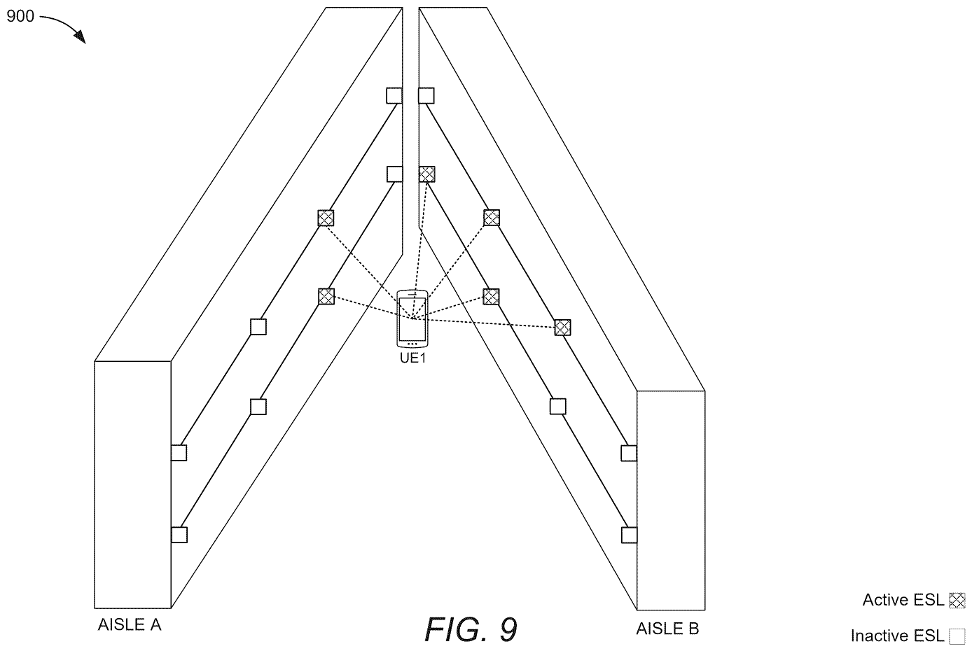

FIG. 9 illustrates an ELS deployment scenario 900, in accordance with an aspect of the disclosure.

Referring to FIG. 9, a dense ESL deployment is depicted with a unique geometry, where the ESLs are deployed regularly on a 2D grid on each side of the aisle. Consider a UE in the middle of the aisle; the UE lights up neighboring ESLs which are in the immediate vicinity, and the UE measures the strength of their RSSI beacons (in a downlink scenario, however uplink use-cases may also be considered). Using only the RSSI beacon values, the distances/ranges from the UE to the ESLs can be inferred (e.g., within a few meters of accuracy). Now, if the location of the UE is known and the relative geometry of the ESL deployment is known as well as shown in the figure, the set of possible locations can be reduced from multiple spheres to a set/group of locations lying in the intersection of the sphere and the grid plane where the ESLs are located.

One example wireless communications protocol may be utilized to support ESL-to-AP signaling is the BLE Generic Attribute Profile (GATT) protocol. For example, ESLs may contain a BLE GATT server, and scan result read characteristics can be defined for eTag RSSI (e.g., for the reporting of eTag RSSI from ESL(s) to the ESL AP) In a further aspect, in addition to RSSI, eTags may send data as well (such as sensor measurements) which may also be part of the GATT frame/packet sent by an ESL to the ESL AP. Advantages of the BLE GATT protocol include support for bulk data read operation, allowing for accumulation and less frequent read of eTag scan results. This can be useful if there are many active eTags. A negative aspect of the BLE GATT protocol is overhead of Bluetooth ACL connect/disconnect for every query which results in slower response time.

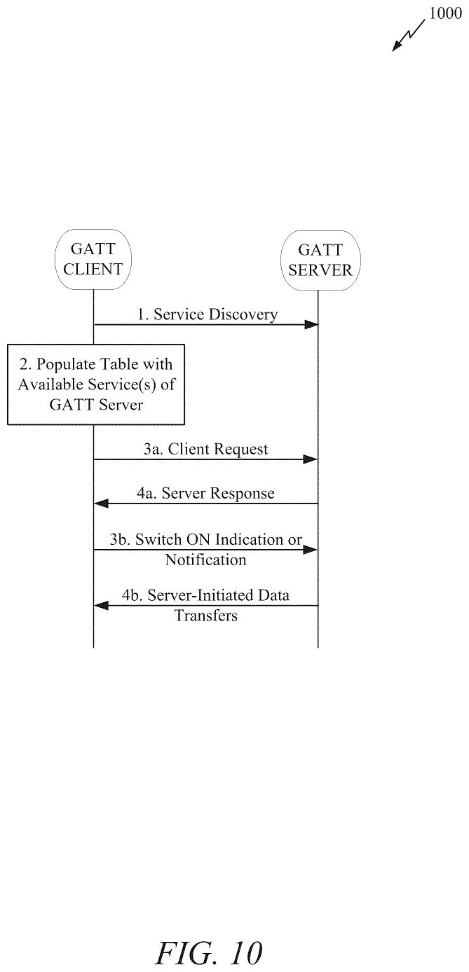

FIG. 10 illustrates Bluetooth Low Energy (BLE) Generic Attribute Profile (GATT) procedure 1000, in accordance with aspects of the disclosure. At (1), a GATT client performs service discovery with a GATT server. At (2), the GATT client populates a table of available service(s) of the GATT server obtained from (1). At (3a), the GATT client transmits a client request to the GATT server. At (4a), the GATT server transmits a server response to the client request from (3a). As an alternative to (or in addition to) (3a)-(4a), at (3b), the GATT client transmits a switch ON indication or notification to the GATT server, and at (4b), the GATT server performs server-initiated data transfers.

Another example wireless communications protocol may be utilized to support ESL-to-AP signaling is the ESL Periodic Advertising with Responses (PAWR) protocol. In ESL PAWR, ESLs can be sent a Vendor Specific command via Advertising Sync Packet and eTag RSSI data can be reported by the ESL in specific Advertisement slot period. ESLs are grouped and addressed as a group (via the group ID). An advantage to this approach is minimum overhead and quick response time. A negative to this approach is the advertisement packet payload size is limited (48 bytes) so only 1 eTag payload (40 bytes) will fit in one slot. Multiple eTags' data may need multiple slots.

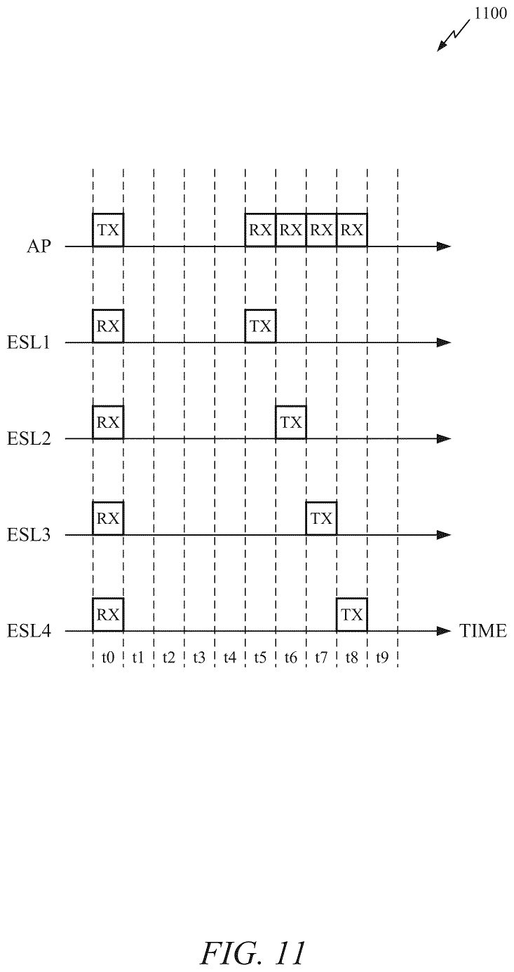

FIG. 11 illustrates ESL Periodic Advertising with Responses (PAWR) scheme 1100, in accordance with aspects of the disclosure. The ESL PAWR scheme 1100 is described with respect to a cluster of ESLs which includes 4 ESLs denoted as ESLs 1-4. At to, the ESL AP transmits scheduling information to ESLs 1-4. Assume that ESLs 1-4 operate in ESL radio scan mode (Rx mode) between t1-t4 (e.g., collecting eTag measurement information). Then, ESLs 1-4 each transmit measurement feedback from the ESL radio scan mode to the ESL AP between t5-t8. As will be appreciated, for highly populated clusters of ESLs, the measurement feedback to the ESL AP can take a significant amount of time and incur high signaling overhead and scheduling overhead.

Aspects of the disclosure are directed to a cluster head associated with a cluster of electronic shelf labels (ESLs). An ESL controller may determine cluster head information associated with selection of at least one cluster head from a cluster of ESLs deployed in a facility (e.g., the ESL controller head may select the cluster head itself or provide a ruleset to the cluster of ESLs for cluster-based determination of the cluster head). In an aspect, an ESL from the cluster of ESLs that acts as a cluster head is tasked with providing feedback to the ESL controller on behalf of the cluster of ESLs. Such aspects provide various technical advantages, such as reduction to signaling overhead and scheduling overhead while also facilitating sufficient payload for the measurement feedback.

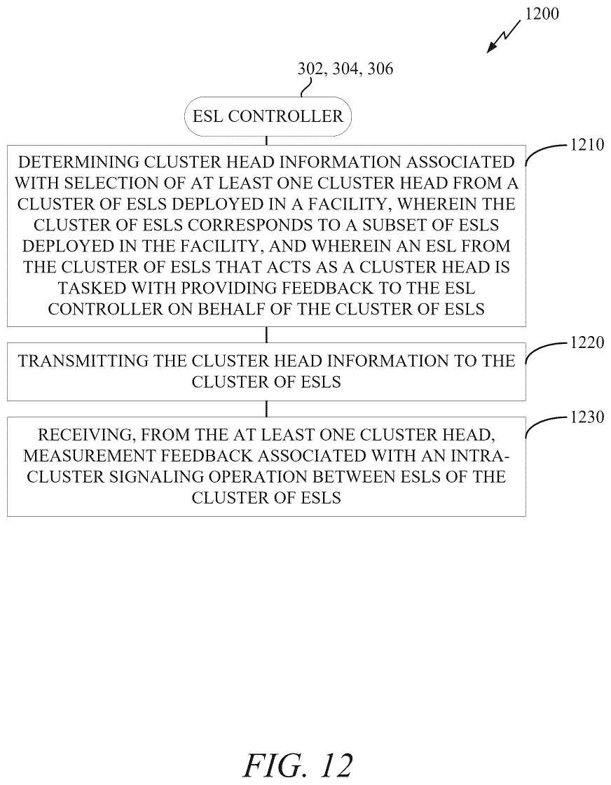

FIG. 12 illustrates an exemplary process 1200 of communications according to an aspect of the disclosure. The process 1200 of FIG. 12 is performed by an ESL controller. In some designs, the ESL controller may correspond to a UE (e.g., UE 302). In some designs, the ESL controller may be integrated at a wireless network component (e.g., ELS AP such as access point 120 which may be configured similarly to gNB/BS/TRP 304, or gNB/BS/TRP 304 or O-RAN component such as RU) or other network component (e.g., network entity 306, an edge server, central management entity 110, etc.). In scenarios where the network component is integrated with another device (e.g., UE/gNB/BS/TRP, LMF, SnMF, etc.), reference to any Rx/Tx operations between the ELS controller and the other device in which the ELS controller is integrated may correspond to transfer of information between different logical components of the device over a data bus, etc.

Referring to FIG. 12, at 1210, the ESL controller (e.g., ESL component 342 or 388 or 398, processor(s) 332 or 384 or 394, etc.) determines cluster head information associated with selection of at least one cluster head from a cluster of ESLs deployed in a facility. In an aspect, the cluster of ESLs corresponds to a subset of ESLs deployed in the facility. In an aspect, an ESL from the cluster of ESLs that acts as a cluster head is tasked with providing feedback to the ESL controller on behalf of the cluster of ESLs. In some designs, a means for performing the determination of 1210 includes ESL component 342 or 388 or 398, processor(s) 332 or 384 or 394, etc., of FIGS. 3A-3C.

Referring to FIG. 12, at 1220, the ESL controller (e.g., transmitter 314 or 324 or 354 or 364, network transceiver(s) 380 or 390, data bus 334 or 382 or 392, etc.) transmits the cluster head information to the cluster of ESLs. In some designs, a means for performing the transmission of 1220 includes transmitter 314 or 324 or 354 or 364, network transceiver(s) 380 or 390, data bus 334 or 382 or 392, etc., of FIGS. 3A-3C.

Referring to FIG. 12, at 1230, the ESL controller (e.g., receiver 312 or 322 or 352 or 362, network transceiver(s) 380 or 390, data bus 334 or 382 or 392, etc.) receives, from the at least one cluster head, measurement feedback associated with an intra-cluster signaling operation between ESLs of the cluster of ESLs. In some designs, a means for performing the reception of 1230 includes receiver 312 or 322 or 352 or 362, network transceiver(s) 380 or 390, data bus 334 or 382 or 392, etc., of FIGS. 3A-3C.

Referring to FIG. 12, in some designs, the cluster head information comprises an indication of the at least one cluster head, or the cluster head information comprises at least one cluster head selection rule to facilitate selection of the at least one cluster head by the cluster of ESLs.

Referring to FIG. 12, in some designs, the at least one cluster head comprises a single cluster head associated with cluster head operation during a single time duration, or the at least one cluster head comprises a first cluster head associated with cluster head operation during a first time duration and a second cluster head associated with cluster head operation during a second time duration.

Referring to FIG. 12, in some designs, the cluster head information is associated with the selection of the at least one cluster head in accordance with a set of criteria comprising, e.g.: a round-robin cluster head selection scheme, or ESL controller connectivity information, or battery resource information associated with the cluster of ESLs, or any combination thereof.

Referring to FIG. 12, in some designs, the cluster of ESLs is geographically co-located within a region of the facility.

Referring to FIG. 12, in some designs, the ESL controller further transmit, to the at least one cluster head, scheduling information associated with relaying of the measurement feedback to the ESL controller. In an aspect, the measurement feedback is received in accordance with the scheduling information. In an aspect, the scheduling information allocates a set of resources for signaling of the measurement feedback that follows resources associated with the intra-cluster signaling operation.

Referring to FIG. 12, in some designs, the measurement feedback is received via Generic Attribute Profile (GATT) signaling, or the measurement feedback is received via Bluetooth signaling, or the measurement feedback is received via ESL periodic advertising with responses (PAWR) protocol, or the measurement feedback is received on a channel that is non-overlapping an intra-cluster communication channel, or any combination thereof.

Referring to FIG. 12, in some designs, the measurement feedback comprises first Received Signal Strength Indicator (RSSI) information associated with the intra-cluster signaling operation, or the measurement feedback comprises a single representative RSSI derived as a function of two or more RSSIs associated with the intra-cluster signaling operation, or the measurement feedback comprises a single representative location associated with the cluster of ESLs, or the measurement feedback comprises second RSSI information that is based on less than all RSSIs associated with the intra-cluster signaling operation, or the measurement feedback is encoded in accordance with a data compression scheme, or any combination thereof.

Referring to FIG. 12, in some designs, the cluster head information is transmitted to the cluster of ESLs via a payload element of an ESL controller beacon message.

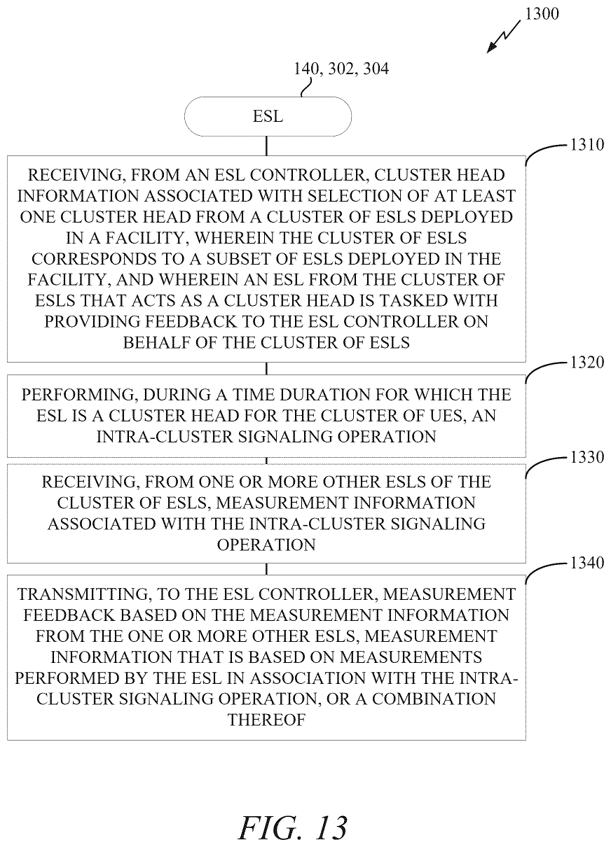

FIG. 13 illustrates an exemplary process 1300 of communications according to an aspect of the disclosure. The process 1300 of FIG. 13 is performed by an ESL, such as ESL 140. In some designs, the ESL may be configured as a UE (e.g., UE 302). In some designs, the ESL may be integrated at a wireless network component (e.g., gNB/BS/TRP 304, or gNB/BS/TRP 304 or O-RAN component such as RU). In scenarios where the ESL is integrated with another device (e.g., UE/gNB/BS/TRP, LMF, SnMF, etc.), reference to any Rx/Tx operations between the ELS and the other device in which the ELS is integrated may correspond to transfer of information between different logical components of the device over a data bus, etc.

Referring to FIG. 13, at 1310, the ESL (e.g., receiver 312 or 322 or 352 or 362, network transceiver(s) 380 or 390, data bus 334 or 382 or 392, etc.) receives, from an ESL controller, cluster head information associated with selection of at least one cluster head from a cluster of ESLs deployed in a facility. In an aspect, the cluster of ESLs corresponds to a subset of ESLs deployed in the facility. In an aspect, an ESL from the cluster of ESLs that acts as a cluster head is tasked with providing feedback to the ESL controller on behalf of the cluster of ESLs. In some designs, a means for performing the reception of 1310 includes receiver 312 or 322 or 352 or 362, network transceiver(s) 380 or 390, data bus 334 or 382 or 392, etc., of FIGS. 3A-3C.

Referring to FIG. 13, at 1320, the ESL (e.g., receiver 312 or 322 or 352 or 362, transmitter 314 or 324 or 354 or 364, etc.) performs, during a time duration for which the ESL is a cluster head for the cluster of UEs, an intra-cluster signaling operation. In some designs, a means for performing the intra-cluster signaling operation of 1320 includes receiver 312 or 322 or 352 or 362, transmitter 314 or 324 or 354 or 364, etc., of FIGS. 3A-3C.

Referring to FIG. 13, at 1330, the ESL (e.g., receiver 312 or 322 or 352 or 362, network transceiver(s) 380 or 390, data bus 334 or 382 or 392, etc.) receives, from one or more other ESLs of the cluster of ESLs, measurement information associated with the intra-cluster signaling operation. In some designs, a means for performing the reception of 1330 includes receiver 312 or 322 or 352 or 362, network transceiver(s) 380 or 390, data bus 334 or 382 or 392, etc., of FIGS. 3A-3C.

Referring to FIG. 13, at 1340, the ESL (e.g., transmitter 314 or 324 or 354 or 364, network transceiver(s) 380 or 390, data bus 334 or 382 or 392, etc.) transmits, to the ESL controller, measurement feedback based on the measurement information from one or more other ESLs, measurement information that is based on measurements performed by the ESL in association with the intra-cluster signaling operation, or a combination thereof. In some designs, a means for performing the transmission of 1340 includes transmitter 314 or 324 or 354 or 364, network transceiver(s) 380 or 390, data bus 334 or 382 or 392, etc., of FIGS. 3A-3C.

Referring to FIG. 13, in some designs, the cluster head information comprises an indication of the at least one cluster head, or the cluster head information comprises at least one cluster head selection rule to facilitate selection of the at least one cluster head by the cluster of ESLs.

Referring to FIG. 13, in some designs, the at least one cluster head comprises a single cluster head associated with cluster head operation during a single time duration, or the at least one cluster head comprises a first cluster head associated with cluster head operation during a first time duration and a second cluster head associated with cluster head operation during a second time duration.

Referring to FIG. 13, in some designs, the cluster head information is associated with the selection of the at least one cluster head in accordance with a set of criteria comprising, e.g.: a round-robin cluster head selection scheme, or ESL controller connectivity information, or battery resource information associated with the cluster of ESLs, or any combination thereof.

Referring to FIG. 13, in some designs, the cluster of ESLs is geographically co-located within a region of the facility.

Referring to FIG. 13, in some designs, the ESL further receives, from the ESL controller, scheduling information associated with relaying of the measurement feedback to the ESL controller. In an aspect, the measurement feedback is transmitted in accordance with the scheduling information. In an aspect, the scheduling information allocates a set of resources for signaling of the measurement feedback that follows resources associated with the intra-cluster signaling operation.

Referring to FIG. 13, in some designs, the measurement feedback is received via Generic Attribute Profile (GATT) signaling, or the measurement feedback is received via Bluetooth signaling, or the measurement feedback is received via ESL periodic advertising with responses (PAWR) protocol, or the measurement feedback is received on a channel that is non-overlapping an intra-cluster communication channel, or any combination thereof.

Referring to FIG. 13, in some designs, the measurement feedback comprises first Received Signal Strength Indicator (RSSI) information associated with the intra-cluster signaling operation, or the measurement feedback comprises a single representative RSSI derived as a function of two or more RSSIs associated with the intra-cluster signaling operation, or the measurement feedback comprises a single representative location associated with the cluster of ESLs, or the measurement feedback comprises second RSSI information that is based on less than all RSSIs associated with the intra-cluster signaling operation, or the measurement feedback is encoded in accordance with a data compression scheme, or any combination thereof.

Referring to FIG. 13, in some designs, the cluster head information is received via a payload element of an ESL controller beacon message.

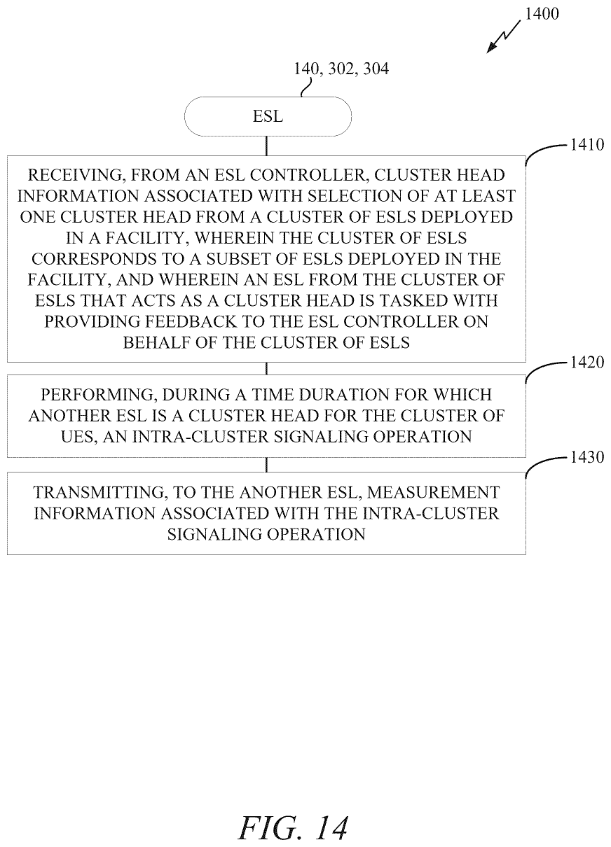

FIG. 14 illustrates an exemplary process 1400 of communications according to an aspect of the disclosure. The process 1400 of FIG. 14 is performed by an ESL, such as ESL 140. In some designs, the ESL may be configured as a UE (e.g., UE 302). In some designs, the ESL may be integrated at a wireless network component (e.g., gNB/BS/TRP 304, or gNB/BS/TRP 304 or O-RAN component such as RU). In scenarios where the ESL is integrated with another device (e.g., UE/gNB/BS/TRP, LMF, SnMF, etc.), reference to any Rx/Tx operations between the ELS and the other device in which the ELS is integrated may correspond to transfer of information between different logical components of the device over a data bus, etc.

Referring to FIG. 14, at 1410, the ESL (e.g., receiver 312 or 322 or 352 or 362, network transceiver(s) 380 or 390, data bus 334 or 382 or 392, etc.) receives, from an ESL controller, cluster head information associated with selection of at least one cluster head from a cluster of ESLs deployed in a facility. In an aspect, the cluster of ESLs corresponds to a subset of ESLs deployed in the facility. In an aspect, an ESL from the cluster of ESLs that acts as a cluster head is tasked with providing feedback to the ESL controller on behalf of the cluster of ESLs. In some designs, a means for performing the reception of 1410 includes receiver 312 or 322 or 352 or 362, network transceiver(s) 380 or 390, data bus 334 or 382 or 392, etc., of FIGS. 3A-3C.

Referring to FIG. 13, at 1420, the ESL (e.g., receiver 312 or 322 or 352 or 362, transmitter 314 or 324 or 354 or 364, etc.) performs, during a time duration for which another ESL is a cluster head for the cluster of UEs, an intra-cluster signaling operation. In some designs, a means for performing the intra-cluster signaling operation of 1420 includes receiver 312 or 322 or 352 or 362, transmitter 314 or 324 or 354 or 364, etc., of FIGS. 3A-3C.

Referring to FIG. 14, at 1430, the ESL (e.g., transmitter 314 or 324 or 354 or 364, network transceiver(s) 380 or 390, data bus 334 or 382 or 392, etc.) transmits, to the another ESL, measurement information associated with the intra-cluster signaling operation. In some designs, a means for performing the transmission of 1430 includes transmitter 314 or 324 or 354 or 364, network transceiver(s) 380 or 390, data bus 334 or 382 or 392, etc., of FIGS. 3A-3C.

Referring to FIG. 14, in some designs, the cluster head information comprises an indication of the at least one cluster head, or the cluster head information comprises at least one cluster head selection rule to facilitate selection of the at least one cluster head by the cluster of ESLs.

Referring to FIG. 14, in some designs, the at least one cluster head comprises a single cluster head associated with cluster head operation during a single time duration, or the at least one cluster head comprises a first cluster head associated with cluster head operation during a first time duration and a second cluster head associated with cluster head operation during a second time duration.

Referring to FIG. 14, in some designs, the cluster head information is associated with the selection of the at least one cluster head in accordance with a set of criteria comprising, e.g.: a round-robin cluster head selection scheme, or ESL controller connectivity information, or battery resource information associated with the cluster of ESLs, or any combination thereof.

Referring to FIG. 14, in some designs, the cluster of ESLs is geographically co-located within a region of the facility.

Referring to FIG. 14, in some designs, the cluster head information is received via a payload element of an ESL controller beacon message.

Referring to FIGS. 12-14, in a specific example, ESL-to-ESL communication may be supported via a low-power advertisement message transmission to ESL AP (instead of a regular advertisement message sent to ESL AP). In an aspect, this can reduce ESL power consumption.

Referring to FIGS. 12-14, in a specific example, a cluster of ESLs can be formed by the edge server (scheduled via the ESL AP) on the basis of, e.g.:
Signal strength (Highest RSSI corresponding to a previous eTag beacon that was received), and/or
Geometry with respect to the most recent position estimate of an eTag, and/or
During an initial discovery phase (for eTags), a cluster may be chosen with a uniform spatial pattern (i.e. every nth ESL).

Referring to FIGS. 12-14, in a specific example, ESL AP may send a schedule as part of the AP sync beacon, comprising cluster head information. In an aspect, the role of a cluster head may be adaptively passed across ESLs every cycle, based on, e.g.: round-robin (e.g., all ESLs in a cluster share the burden equally), and/or connectivity to AP (e.g., ESL with best connectivity metrics i.e. SNR, RSSI, etc. is chosen to report all the data reliably), and/or remaining battery resources (e.g., ESL with most amount of remaining battery is chosen as the cluster head). In an aspect, clusters may also be formed on the basis of ESL deployment. For example, a cluster of ESL radios may belong to gondola 1, another cluster to gondola 2 and so on. In an aspect, the same generalization may be made to multiple units of shelves or gondolas. In an aspect, each of the clusters may be associated with its own unique cluster head.

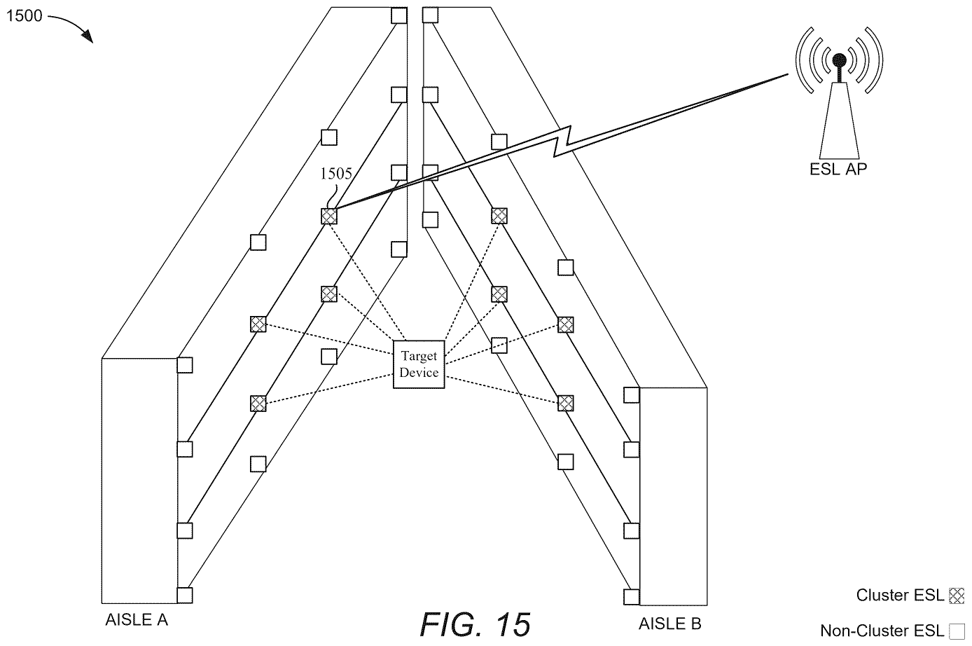

FIG. 15 illustrates an example implementation 1500 of the processes of FIGS. 12-14 of processes 1200-1400, respectively, in accordance with aspects of the disclosure. In FIG. 15, ESL 1505 is designated as the cluster head for a cluster of ESLs.

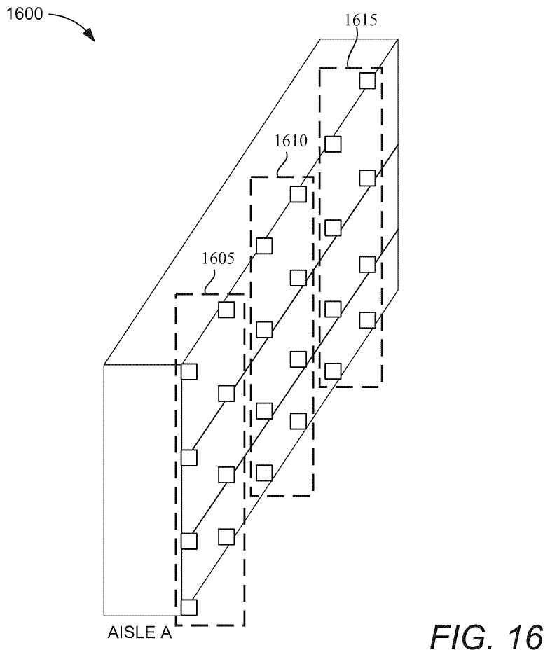

FIG. 16 illustrates an example implementation 1600 of the processes of FIGS. 12-14 of processes 1200-1400, respectively, in accordance with aspects of the disclosure. In FIG. 16, three clusters of ESLs on a single aisle (Aisle A) are depicted as which with respect to 1605, 1610 and 1615.

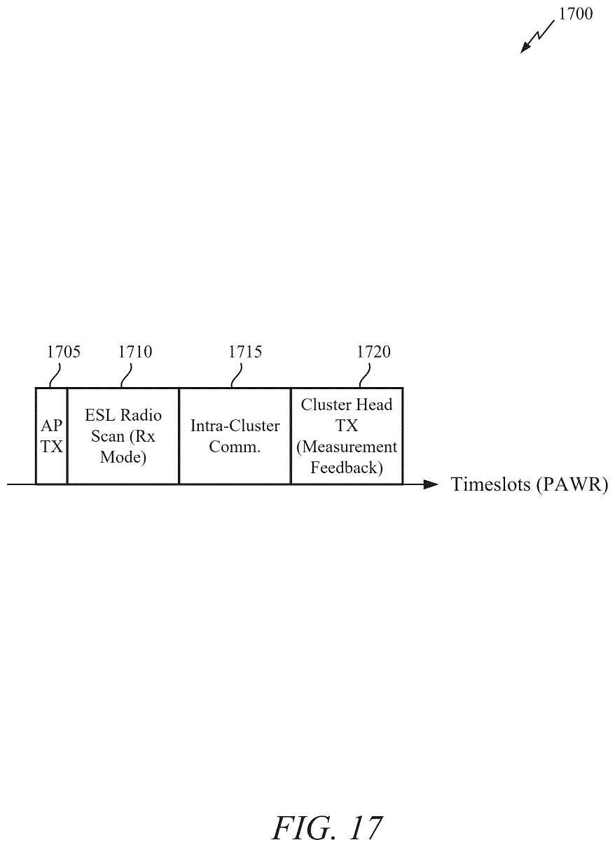

Referring to FIGS. 12-14, in a specific example, scheduling for the link between the cluster head and ESL AP may be implemented via regular advertisement transmission between a cluster of ESLs. In an aspect, the scheduling may be performed via PAWR-based scheduling. In an aspect, the cluster head may be scheduled via one or more time slots for relaying the data, as depicted in FIG. 17. In an aspect related to PAWR-based scheduling, the maximum time period of scheduled slots (or max number of time slots) may be capped by the size of the cluster (e.g., larger clusters transmit more data, and thereby may require more time to transmit the data to the ESL AP). In an aspect, this group of slots may occur later in time, as compared to the time resources allocated to intra-cluster communication, as depicted in FIG. 17.

FIG. 17 illustrates an example implementation 1700 of the processes of FIGS. 12-14 of processes 1200-1400, respectively, in accordance with aspects of the disclosure. In FIG. 17, an ESL AP scheduling transmission occurs at 1705, followed by ESL radio scan mode 1710 (e.g., for eTag detection, etc.). At 1715, intra-cluster communication is performed (e.g., to pass measurement feedback from the non-cluster head ESLs to the cluster head ESL). At 1720, the cluster head transmits measurement feedback to the ESL AP (e.g., which may correspond to the ESL controller or may be communicatively coupled to the ESL controller).

Referring to FIGS. 12-14, in a specific example, scheduling for the link between the cluster head and ESL AP may be implemented via GATT-based scheduling. In an aspect, the amalgamated report may be sent from the cluster head to the ESL AP over GATT protocol instead of PAWR. In an aspect, a connection-oriented protocol such as GATT may be preferable (as compared to PAWR) since the amalgamated data from several ESL radios can be reliably delivered to the ESL AP (and later to the edge server). In an aspect, a non-overlapping data channel may be used by the cluster head, which does not interfere with or affect the operation of an ongoing PAWR scheme/session (which occurs over advertisement channels).

Referring to FIGS. 12-14, in a specific example, the scheduling information for the link between the cluster head and ESL AP may also indicate to the cluster head to perform data compression. In an aspect, the cluster head provides a single representative RSSI (e.g., the cluster head obtains N RSSIs and converts the N RSSIs to a single RSSI) and a single representative location for the cluster (e.g., instead of indicating location for each ESL that provides RSSI), which can significantly reduce overhead and packet size. In an aspect, the representative RSSI may be a statistic (mean/median/standard deviation) of the individual RSSIs corresponding to each of the ESL radios in the cluster. In an aspect, the representative location may be a function of the individual RSSIs, and may be represented by an ESL radio id within the cluster (e.g., an indication of ESL ID #8 can mean that the representative location for the cluster is the location of ESL #8 within the cluster). In an aspect, this provides the ESL AP with a top-level view of the representative RSSIs per shelf/gondola. In an aspect, the resultant position estimate may be a function of the representative RSSIs. In an aspect, the cluster head discards data received from a subset of the ESL radios within the cluster (such as low RSSI, high uncertainty metric, low SNR, etc.). Another way of representing this information in the schedule may be to retain only a first threshold amount of data from a second threshold number of ESL radios. In an aspect, the cluster head may perform a type of source coding, such as Huffman coding or LZW coding, along with associated parameters.

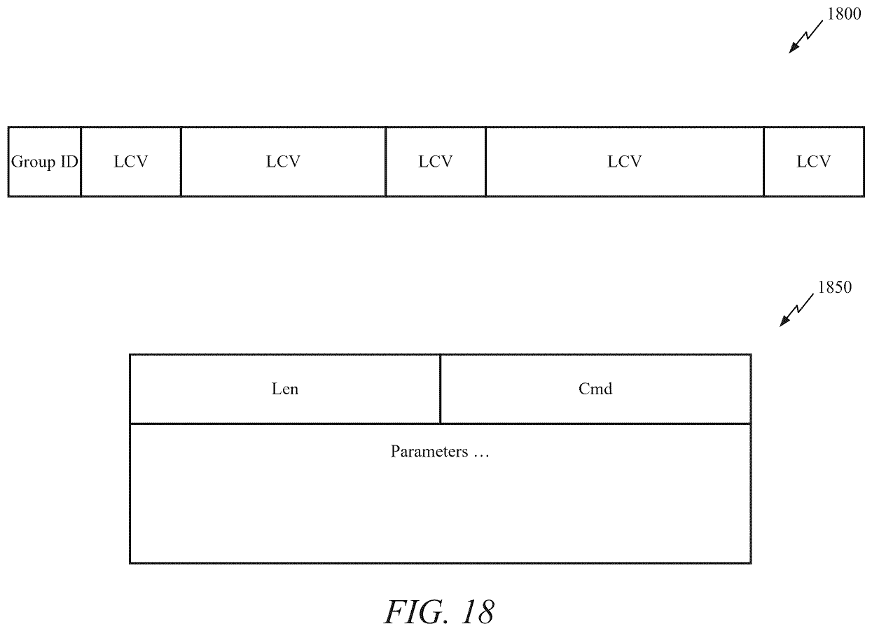

Referring to FIGS. 12-14, in a specific example, the scheduling information may be performed. In an aspect, an ESL AP may query and send a command to a given ESL radio through the ‘ESL payload’ element of its AP beacon message, as depicted in FIG. 18.

FIG. 18 illustrates an example implementation of the processes of FIGS. 12-14 of processes, respectively, in accordance with aspects of the disclosure. In particular, the FIG. 18 illustrates ESL payload configurations 1800-1850, as described above.

Referring to FIG. 18, in a specific example, the LCV (Len Cmd Value) contains an ESL command (Cmd element), which may be vendor-specific (an opcode of Ox F, wherein {Len, Cmd} define a unique opcode). In an aspect, the first octet or byte of the ‘Parameters’ element refers to the ELS identifier (Eid), which enables an ESL radio to determine that the corresponding Cmd is intended for it. In an aspect, this vendor-specific portion may be utilized to define our proposed operations such as, e.g.:
0x1F: “Assume the role of a cluster head”
0x7F: “5 time slots for transmission to the ESL AP”
0x13: “Apply Huffman coding”

In an aspect, by following the above schedule, the cluster head reports all the amalgamated information (from other ESLs in the cluster) to AP, over a regular advertisement.

Aspects are directed to intra-cluster transmission power associated with a cluster of electronic shelf labels (ESLs). In an aspect, an ESL controller determines a signaling configuration associated with intra-cluster signaling operation between ESLs of a cluster of ESLs deployed in a facility. In an aspect, the signaling configuration comprises a time-frequency (T-F) resource configuration, and a transmission power configuration that configures intra-cluster transmission power based on distances between respective ESLs of the cluster of ESLs and a designated ESL (i.e., cluster head) of the first cluster of ESLs. In an aspect, the ESL controller transmits the signaling configuration to the cluster of ESLs. The ESL(s) perform an intra-cluster signaling operation in accordance with the signaling configuration an intra-cluster signaling operation in accordance with the signaling configuration. Such aspects may provide various technical advantages, such as interference mitigation, improved ESL cluster scheduling, and so on.

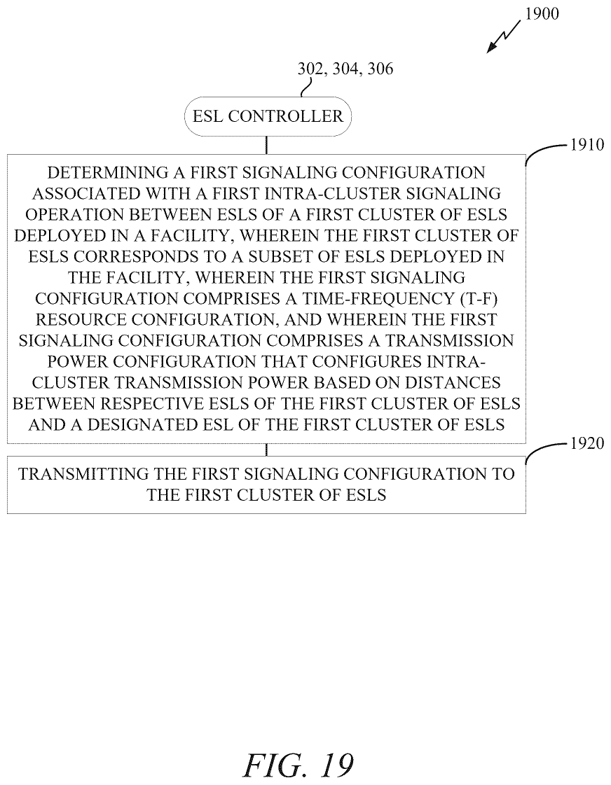

FIG. 19 illustrates an exemplary process 1900 of communications according to an aspect of the disclosure. The process 1900 of FIG. 19 is performed by an ESL controller. In some designs, the ESL controller may correspond to a UE (e.g., UE 302). In some designs, the ESL controller may be integrated at a wireless network component (e.g., ELS AP such as access point 120 which may be configured similarly to gNB/BS/TRP 304, or gNB/BS/TRP 304 or O-RAN component such as RU) or other network component (e.g., network entity 306, an edge server, central management entity 110, etc.). In scenarios where the network component is integrated with another device (e.g., UE/gNB/BS/TRP, LMF, SnMF, etc.), reference to any Rx/Tx operations between the ELS controller and the other device in which the ELS controller is integrated may correspond to transfer of information between different logical components of the device over a data bus, etc.

Referring to FIG. 19, at 1910, the ESL controller (e.g., ESL component 342 or 388 or 398, processor(s) 332 or 384 or 394, etc.) determines a first signaling configuration associated with a first intra-cluster signaling operation between ESLs of a first cluster of ESLs deployed in a facility. In an aspect, the first cluster of ESLs corresponds to a subset of ESLs deployed in the facility. In an aspect, the first signaling configuration comprises a time-frequency (T-F) resource configuration. In an aspect, the first signaling configuration comprises a transmission power configuration that configures intra-cluster transmission power based on distances between respective ESLs of the first cluster of ESLs and a designated ESL of the first cluster of ESLs. In some designs, a means for performing the determination of 1910 includes ESL component 342 or 388 or 398, processor(s) 332 or 384 or 394, etc., of FIGS. 3A-3C.

Referring to FIG. 19, at 1920, the ESL controller (e.g., transmitter 314 or 324 or 354 or 364, network transceiver(s) 380 or 390, data bus 334 or 382 or 392, etc.) transmits the first signaling configuration to the first cluster of ESLs. In some designs, a means for performing the transmission of 1920 includes transmitter 314 or 324 or 354 or 364, network transceiver(s) 380 or 390, data bus 334 or 382 or 392, etc., of FIGS. 3A-3C.

Referring to FIG. 19, in some designs, the designated ESL corresponds to a cluster head that is tasked with providing feedback to the ESL controller on behalf of the cluster of ESLs in association with measurements associated with the first intra-cluster signaling operation. In an aspect, the ESL controller further receives, from the cluster head, measurement feedback associated with the first intra-cluster signaling operation. In an aspect, the first cluster of ESLs comprises a first sub-cluster of ESLs and a second sub-cluster of ESLs. In an aspect, the first signaling configuration configures, during a first time duration, only the first sub-cluster to transmit measurement information associated with the first intra-cluster signaling operation to the cluster head, and the first signaling configuration configures, during a second time duration, only the second sub-cluster to transmit measurement information associated with the first intra-cluster signaling operation to the cluster head.

Referring to FIG. 19, in some designs, the transmission power configuration allocates transmission power in proportion to the distances between the respective ESLs of the first cluster of ESLs and the designated ESL, or the transmission power configuration is based on historical measurement feedback from one or more historical intra-cluster signaling operations associated with the first cluster of ESLs, or the transmission power configuration comprises a set of transmission power values associated with a respective set of the ESLs in the first cluster of ESLs, or the transmission power configuration comprises a decay function that reduces transmission power over time, or the transmission power configuration reduces transmission power from at least one ESL in the first cluster of ESLs relative to at least one corresponding transmission power from the at least one ESL associated with the one or more historical intra-cluster signaling operations based on the historical measurement feedback, or any combination thereof.

Referring to FIG. 19, in some designs, the ESL controller further determines a second signaling configuration associated with a second intra-cluster signaling operation between ESLs of a second cluster of ESLs deployed in the facility. In an aspect, the second signaling configuration comprises a respective T-F resource configuration that is non-overlapping with respect to the T-F resource configuration. In an aspect, the ESL controller further transmits the second signaling configuration to the second cluster of ESLs.

Referring to FIG. 19, in some designs, the first signaling configuration is transmitted to the cluster of ESLs via a payload element of an ESL controller beacon message.

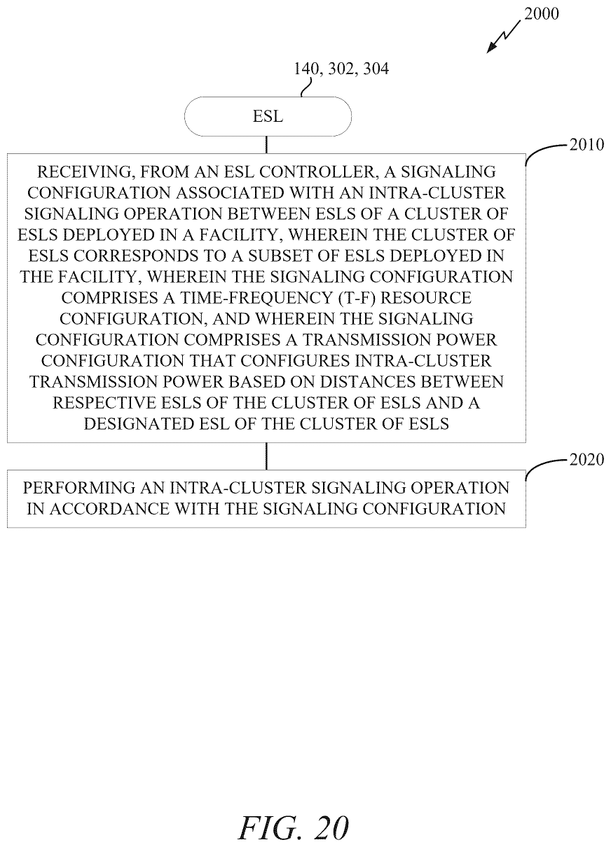

FIG. 20 illustrates an exemplary process 2000 of communications according to an aspect of the disclosure. The process 2000 of FIG. 20 is performed by an ESL, such as ESL 140. In some designs, the ESL may be configured as a UE (e.g., UE 302). In some designs, the ESL may be integrated at a wireless network component (e.g., gNB/BS/TRP 304, or gNB/BS/TRP 304 or O-RAN component such as RU). In scenarios where the ESL is integrated with another device (e.g., UE/gNB/BS/TRP, LMF, SnMF, etc.), reference to any Rx/Tx operations between the ELS and the other device in which the ELS is integrated may correspond to transfer of information between different logical components of the device over a data bus, etc.

Referring to FIG. 20, at 2010, the ESL (e.g., receiver 312 or 322 or 352 or 362, network transceiver(s) 380 or 390, data bus 334 or 382 or 392, etc.) receives, from an ESL controller, a signaling configuration associated with an intra-cluster signaling operation between ESLs of a cluster of ESLs deployed in a facility. In an aspect, the cluster of ESLs corresponds to a subset of ESLs deployed in the facility. In an aspect, the signaling configuration comprises a time-frequency (T-F) resource configuration. In an aspect, the signaling configuration comprises a transmission power configuration that configures intra-cluster transmission power based on distances between respective ESLs of the cluster of ESLs and a designated ESL of the cluster of ESLs. In some designs, a means for performing the reception of 2010 includes receiver 312 or 322 or 352 or 362, network transceiver(s) 380 or 390, data bus 334 or 382 or 392, etc., of FIGS. 3A-3C.

Referring to FIG. 20, at 2020, the ESL (e.g., receiver 312 or 322 or 352 or 362, transmitter 314 or 324 or 354 or 364, etc.) performs an intra-cluster signaling operation in accordance with the signaling configuration. In some designs, a means for performing the intra-cluster signaling operation of 2020 includes receiver 312 or 322 or 352 or 362, transmitter 314 or 324 or 354 or 364, etc., of FIGS. 3A-3C.

Referring to FIG. 20, in some designs, the ESL further receives, during a time duration for which the ESL is the designated ESL, measurement information associated with the intra-cluster signaling operation, and transmits, to the ESL controller, measurement feedback based on the measurement information from one or more other ESLs, measurement information that is based on measurements performed by the ESL in association with the intra-cluster signaling operation, or a combination thereof.

Referring to FIG. 20, in some designs, the ESL further performs, during a time duration for which another ESL is the designated ESL, the intra-cluster signaling operation, and transmits, to the designated ESL, measurement information associated with the intra-cluster signaling operation.

Referring to FIG. 20, in some designs, the designated ESL corresponds to a cluster head that is tasked with providing feedback to the ESL controller on behalf of the cluster of ESLs in association with measurements associated with the intra-cluster signaling operation. In an aspect, the cluster of ESLs comprises a first sub-cluster of ESLs and a second sub-cluster of ESLs. In an aspect, the signaling configuration configures, during a first time duration, only the first sub-cluster to transmit measurement information associated with the intra-cluster signaling operation to the cluster head, and the signaling configuration configures, during a second time duration, only the second sub-cluster to transmit measurement information associated with the intra-cluster signaling operation to the cluster head.

Referring to FIG. 20, in some designs, the transmission power configuration allocates transmission power in proportion to the distances between the respective ESLs of the cluster of ESLs and the designated ESL, or the transmission power configuration is based on historical measurement feedback from one or more historical intra-cluster signaling operations associated with the cluster of ESLs, or the transmission power configuration comprises a set of transmission power values associated with a respective set of the ESLs in the cluster of ESLs, or the transmission power configuration comprises a decay function that reduces transmission power over time, or the transmission power configuration reduces transmission power from at least one ESL in the cluster of ESLs relative to at least one corresponding transmission power from the at least one ESL associated with the one or more historical intra-cluster signaling operations based on the historical measurement feedback, or any combination thereof.

Referring to FIG. 20, in some designs, the signaling configuration is received via a payload element of an ESL controller beacon message.

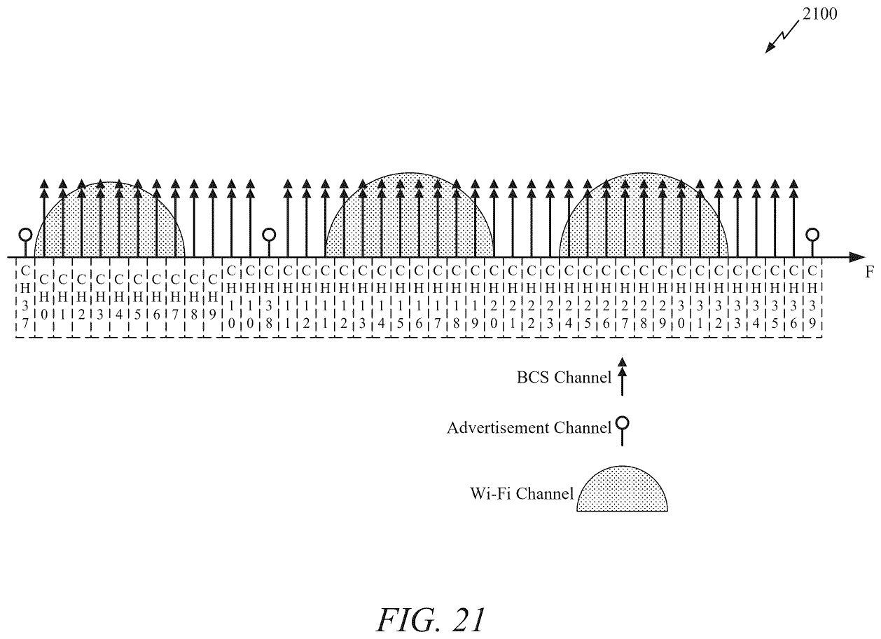

FIG. 21 illustrates Bluetooth channel configuration 2100, in accordance with aspects of the disclosure. In FIG. 13, channels CH0 through CH39 are depicted, which span a 2.4 GHz band. In some designs, CH0-CH39 span from 2402 MHz to 2480 MHz. CH0-CH36 are Bluetooth Low Energy (BLE) channels for Bluetooth channel sounding (BCS) operations, while CH37-CH39 are advertisement channels. As shown in FIG. 21, there is a significant portion of overlap between the Wi-Fi operations and BLE channels over the 2.4 GHz bands. When a Wi-Fi channel is being used, the current default behaviour in BCS is to simply skip these channels/tones during a BCS procedure. This affects ranging accuracy since all the tones cannot be used, and non-contiguities are introduced.

Referring to FIGS. 19-20, in a specific example, the AP sync beacon may comprise scheduling information using low-power advertisement transmission amongst a cluster of ESLs. In an aspect, the scheduling information (also referred to above as signaling configuration) may configure time-frequency (T-F) resources (e.g., a set of time slots and channels that may be used by each of the ESL radios in the cluster; note: there may be specific resources set aside for each ESL radio-to-cluster head link).

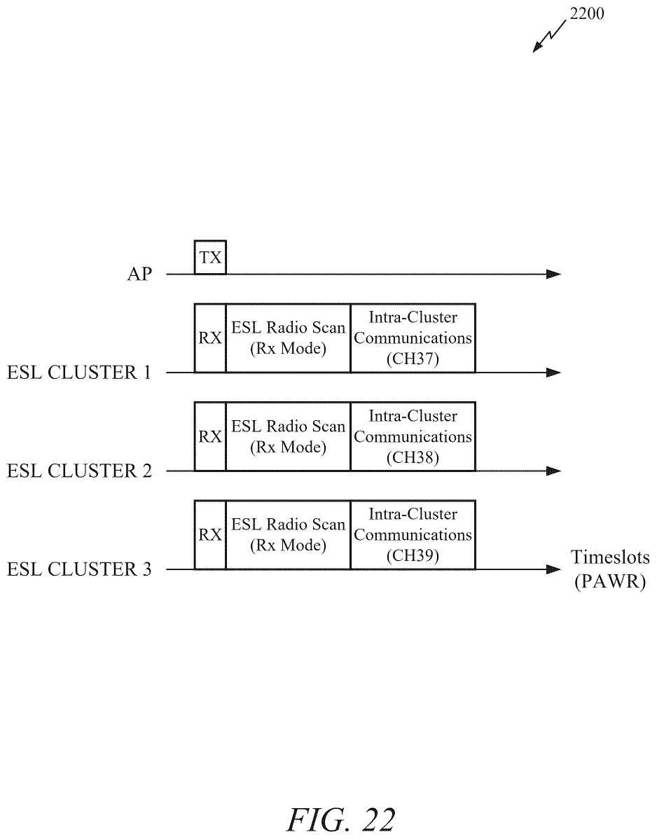

Referring to FIGS. 19-20, in a specific example, the T-F resources may be overlapping with time slots reserved for other ESL radios that are at least a threshold distance away from the cluster (frequency-reuse) e.g., cluster in Aisle 1 is active while another cluster in Aisle 3 is also active over the same channel. This aspect is depicted in FIG. 22.

FIG. 22 illustrates an example implementation 2200 of the processes of FIGS. 19-20 of processes 1900-2000, respectively, in accordance with aspects of the disclosure. In FIG. 22, an ESL AP scheduling transmission occurs, which is monitored by ESL clusters 1, 2 and 3. The ESL AP scheduling transmission is followed by ESL radio scan modes at ESL clusters 1, 2 and 3 (e.g., for eTag detection, etc.), followed by intra-cluster communications at ESL clusters 1, 2 and 3. In this example, ESL clusters 1, 2 and 3 operate on different Bluetooth advertising channels: CH37, CH38 and CH39, respectively (see FIG. 21).

Referring to FIG. 22, in a specific example, the scheduling information signaling may be integrated with PAWR framework. In an aspect, EiD of the ESL radios may be specified, along with time slot and channel information to be used, e.g.:

TABLE 1
PAWR Signaling Configuration

| | | Cluster | In Sub- | | |
|---|---|---|---|---|---|
| EiD | Cluster ID | Head? | Cluster? | Timeslot | Channel |
| 1 | 1 | N | Y | 6 | 37 |
| 2 | 2 | N | Y | 6 | 38 |
| 3 | 3 | N | N | — | — |
| 4 | 1 | N | Y | 7 | 37 |

In an aspect, the scheduling information depicted in the example of Table 1 (above) may be signaled in a vendor-specific field of LCV, as described above with respect to FIG. 18.

Referring to FIGS. 19-20, in a specific example, the scheduling information may also indicate a periodicity with which a sub-cluster of ESL radios relay data to the cluster head (while the others remain idle). In other words, the cluster and cluster head may remain the same, while the sub-cluster changes every cycle. In an aspect, the sub-cluster is an individually controllable sub-groupings of ESLs in a cluster of ESLs. So, one sub-cluster may be toggled OFF (i.e., deactivated) while another sub-cluster is toggled ON (e.g., activated) to reduce power consumption, interference, etc. In an aspect, in case there are insufficient time resources (number of time slots) available for the cluster head to relay data to the ESL AP, a sub-cluster may be imposed.

Referring to FIGS. 19-20, in a specific example, ESL locations may be known, such that the inter-ESL distance is also known (or at least, determinable), and this information may be leveraged for link-budget planning and/or power conservation. In an aspect, Tx power may be scaled proportionally based on link distance between the ESL radio and cluster head (e.g., a higher Tx power (but still relatively low) for longer distance may be implemented, and vice-versa). In an aspect, a mapping may be provided for a Tx power value and a pair of EiDs, e.g.:

TABLE 2
ESL Transmission Power Mapping

| EiD 1 | EiD 2 | Tx Power (dBm) |
|---|---|---|
| 1 | 2 | −5 |
| 1 | 3 | −8 |
| 2 | 4 | −2 |
| 3 | 5 | 0 |

Referring to FIGS. 19-20, in a specific example related to Table 2 (above), the Tx power mapping may be provided as part of the schedule in the AP beacon, or may have been provided previously and stored in the ESL radios (e.g., in non-volatile memory). In an aspect, this mapping may be learnt through RSSI measurements made by the cluster head (for each of the ESL radios in the cluster) and reported to the edge server. In an aspect, the edge server may schedule the Tx power of the ESL radios to be progressively reduced such that packets are still reliably received by the cluster head.

Referring to FIGS. 19-20, in a specific example, the Tx power for each ESL radio may also be updated over time as a function of inter-cluster measurements. For instance, EiD 1 in cluster 1 may measure a signal strength corresponding to EiD 2 in cluster 2, and relay the RSSI to the edge server (via the cluster head and ESL AP). In an aspect, the Edge server may accordingly update Tx power across several clusters (can be interpreted as power control) in order to mitigate inter-cluster interference (when two or more clusters are using the same channel).

Referring to FIGS. 19-20, in a specific example related to the formatting of schedule information, an ESL AP may query and send a command to a given ESL radio through the ‘ESL payload’ element of its AP beacon message (e.g., see discussion of FIG. 18, above). More specifically, the LCV (Len Cmd Value) contains an ESL command (Cmd element), which may be vendor-specific (an opcode of 0x_F, wherein {Len, Cmd} define a unique opcode). In an aspect, the first octet or byte of the ‘Parameters’ element refers to the Eid, which enables an ESL radio to determine that the corresponding Cmd is intended for it. In an aspect, this vendor-specific portion may be utilized to define our proposed operations such as, e.g.:
0x1F: “Assume the role of a low-power ESL radio”
0x7F: “Use time slot 6 over channel 37”

Referring to FIGS. 19-20, in a specific example, following the above schedule, a cluster of ESLs scan for eTag information and relay data to the cluster head over a low-power advertisement.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method performed by an electronic shelf label (ESL) controller, comprising: determining a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmitting the first signaling configuration to the first cluster of ESLs.

Clause 2. The method of clause 1, wherein the designated ESL corresponds to a cluster head that is tasked with providing feedback to the ESL controller on behalf of the cluster of ESLs in association with measurements associated with the first intra-cluster signaling operation.

Clause 3. The method of clause 2, further comprising: receiving, from the cluster head, measurement feedback associated with the first intra-cluster signaling operation.

Clause 4. The method of any of clauses 2 to 3, wherein the first cluster of ESLs comprises a first sub-cluster of ESLs and a second sub-cluster of ESLs.

Clause 5. The method of clause 4, wherein the first signaling configuration configures, during a first time duration, only the first sub-cluster to transmit measurement information associated with the first intra-cluster signaling operation to the cluster head, and wherein the first signaling configuration configures, during a second time duration, only the second sub-cluster to transmit measurement information associated with the first intra-cluster signaling operation to the cluster head.

Clause 6. The method of any of clauses 1 to 5, wherein the transmission power configuration allocates transmission power in proportion to the distances between the respective ESLs of the first cluster of ESLs and the designated ESL, or wherein the transmission power configuration is based on historical measurement feedback from one or more historical intra-cluster signaling operations associated with the first cluster of ESLs, or wherein the transmission power configuration comprises a set of transmission power values associated with a respective set of the ESLs in the first cluster of ESLs, or wherein the transmission power configuration comprises a decay function that reduces transmission power over time, or wherein the transmission power configuration reduces transmission power from at least one ESL in the first cluster of ESLs relative to at least one corresponding transmission power from the at least one ESL associated with the one or more historical intra-cluster signaling operations based on the historical measurement feedback, or any combination thereof.

Clause 7. The method of any of clauses 1 to 6, further comprising: determining a second signaling configuration associated with a second intra-cluster signaling operation between ESLs of a second cluster of ESLs deployed in the facility, wherein the second signaling configuration comprises a respective T-F resource configuration that is non-overlapping with respect to the T-F resource configuration; and transmitting the second signaling configuration to the second cluster of ESLs.

Clause 8. The method of any of clauses 1 to 7, wherein the first signaling configuration is transmitted to the cluster of ESLs via a payload element of an ESL controller beacon message.

Clause 9. A method performed by an electronic shelf label (ESL), comprising: receiving, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and performing an intra-cluster signaling operation in accordance with the signaling configuration.

Clause 10. The method of clause 9, receiving, during a time duration for which the ESL is the designated ESL, measurement information associated with the intra-cluster signaling operation; and transmitting, to the ESL controller, measurement feedback based on the measurement information from one or more other ESLs, measurement information that is based on measurements performed by the ESL in association with the intra-cluster signaling operation, or a combination thereof.

Clause 11. The method of any of clauses 9 to 10, further comprising: performing, during a time duration for which another ESL is the designated ESL, the intra-cluster signaling operation; and transmitting, to the designated ESL, measurement information associated with the intra-cluster signaling operation.

Clause 12. The method of any of clauses 9 to 11, wherein the designated ESL corresponds to a cluster head that is tasked with providing feedback to the ESL controller on behalf of the cluster of ESLs in association with measurements associated with the intra-cluster signaling operation.

Clause 13. The method of clause 12, wherein the cluster of ESLs comprises a first sub-cluster of ESLs and a second sub-cluster of ESLs.

Clause 14. The method of clause 13, wherein the signaling configuration configures, during a first time duration, only the first sub-cluster to transmit measurement information associated with the intra-cluster signaling operation to the cluster head, and wherein the signaling configuration configures, during a second time duration, only the second sub-cluster to transmit measurement information associated with the intra-cluster signaling operation to the cluster head.

Clause 15. The method of any of clauses 9 to 14, wherein the transmission power configuration allocates transmission power in proportion to the distances between the respective ESLs of the cluster of ESLs and the designated ESL, or wherein the transmission power configuration is based on historical measurement feedback from one or more historical intra-cluster signaling operations associated with the cluster of ESLs, or wherein the transmission power configuration comprises a set of transmission power values associated with a respective set of the ESLs in the cluster of ESLs, or wherein the transmission power configuration comprises a decay function that reduces transmission power over time, or wherein the transmission power configuration reduces transmission power from at least one ESL in the cluster of ESLs relative to at least one corresponding transmission power from the at least one ESL associated with the one or more historical intra-cluster signaling operations based on the historical measurement feedback, or any combination thereof.

Clause 16. The method of any of clauses 9 to 15, wherein the signaling configuration is received via a payload element of an ESL controller beacon message.

Clause 17. An electronic shelf label (ESL) controller, comprising: one or more memories; one or more transceivers; and one or more processors communicatively coupled to the one or more memories and the one or more transceivers, wherein the one or more processors, either alone or in combination, are configured to: determine a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmit, via the one or more transceivers, the first signaling configuration to the first cluster of ESLs.

Clause 18. The ESL controller of clause 17, wherein the designated ESL corresponds to a cluster head that is tasked with providing feedback to the ESL controller on behalf of the cluster of ESLs in association with measurements associated with the first intra-cluster signaling operation.

Clause 19. The ESL controller of clause 18, wherein the one or more processors, either alone or in combination, are further configured to: receive, via the one or more transceivers, from the cluster head, measurement feedback associated with the first intra-cluster signaling operation.

Clause 20. The ESL controller of any of clauses 18 to 19, wherein the first cluster of ESLs comprises a first sub-cluster of ESLs and a second sub-cluster of ESLs.

Clause 21. The ESL controller of clause 20, wherein the first signaling configuration configures, during a first time duration, only the first sub-cluster to transmit measurement information associated with the first intra-cluster signaling operation to the cluster head, and wherein the first signaling configuration configures, during a second time duration, only the second sub-cluster to transmit measurement information associated with the first intra-cluster signaling operation to the cluster head.

Clause 22. The ESL controller of any of clauses 17 to 21, wherein the transmission power configuration allocates transmission power in proportion to the distances between the respective ESLs of the first cluster of ESLs and the designated ESL, or wherein the transmission power configuration is based on historical measurement feedback from one or more historical intra-cluster signaling operations associated with the first cluster of ESLs, or wherein the transmission power configuration comprises a set of transmission power values associated with a respective set of the ESLs in the first cluster of ESLs, or wherein the transmission power configuration comprises a decay function that reduces transmission power over time, or wherein the transmission power configuration reduces transmission power from at least one ESL in the first cluster of ESLs relative to at least one corresponding transmission power from the at least one ESL associated with the one or more historical intra-cluster signaling operations based on the historical measurement feedback, or any combination thereof.

Clause 23. The ESL controller of any of clauses 17 to 22, wherein the one or more processors, either alone or in combination, are further configured to: determine a second signaling configuration associated with a second intra-cluster signaling operation between ESLs of a second cluster of ESLs deployed in the facility, wherein the second signaling configuration comprises a respective T-F resource configuration that is non-overlapping with respect to the T-F resource configuration; and transmit, via the one or more transceivers, the second signaling configuration to the second cluster of ESLs.

Clause 24. The ESL controller of any of clauses 17 to 23, wherein the first signaling configuration is transmitted to the cluster of ESLs via a payload element of an ESL controller beacon message.

Clause 25. An electronic shelf label (ESL), comprising: one or more memories; one or more transceivers; and one or more processors communicatively coupled to the one or more memories and the one or more transceivers, wherein the one or more processors, either alone or in combination, are configured to: receive, via the one or more transceivers, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and perform an intra-cluster signaling operation in accordance with the signaling configuration.

Clause 26. The ESL of clause 25, receive, via the one or more transceivers, during a time duration for which the ESL is the designated ESL, measurement information associated with the intra-cluster signaling operation; and transmit, via the one or more transceivers, to the ESL controller, measurement feedback based on the measurement information from one or more other ESLs, measurement information that is based on measurements performed by the ESL in association with the intra-cluster signaling operation, or a combination thereof.

Clause 27. The ESL of any of clauses 25 to 26, wherein the one or more processors, either alone or in combination, are further configured to: perform during a time duration for which another ESL is the designated ESL, the intra-cluster signaling operation; and transmit, via the one or more transceivers, to the designated ESL, measurement information associated with the intra-cluster signaling operation.

Clause 28. The ESL of any of clauses 25 to 27, wherein the designated ESL corresponds to a cluster head that is tasked with providing feedback to the ESL controller on behalf of the cluster of ESLs in association with measurements associated with the intra-cluster signaling operation.

Clause 29. The ESL of clause 28, wherein the cluster of ESLs comprises a first sub-cluster of ESLs and a second sub-cluster of ESLs.

Clause 30. The ESL of clause 29, wherein the signaling configuration configures, during a first time duration, only the first sub-cluster to transmit measurement information associated with the intra-cluster signaling operation to the cluster head, and wherein the signaling configuration configures, during a second time duration, only the second sub-cluster to transmit measurement information associated with the intra-cluster signaling operation to the cluster head.

Clause 31. The ESL of any of clauses 25 to 30, wherein the transmission power configuration allocates transmission power in proportion to the distances between the respective ESLs of the cluster of ESLs and the designated ESL, or wherein the transmission power configuration is based on historical measurement feedback from one or more historical intra-cluster signaling operations associated with the cluster of ESLs, or wherein the transmission power configuration comprises a set of transmission power values associated with a respective set of the ESLs in the cluster of ESLs, or wherein the transmission power configuration comprises a decay function that reduces transmission power over time, or wherein the transmission power configuration reduces transmission power from at least one ESL in the cluster of ESLs relative to at least one corresponding transmission power from the at least one ESL associated with the one or more historical intra-cluster signaling operations based on the historical measurement feedback, or any combination thereof.

Clause 32. The ESL of any of clauses 25 to 31, wherein the signaling configuration is received via a payload element of an ESL controller beacon message.

Clause 33. An electronic shelf label (ESL) controller, comprising: means for determining a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and means for transmitting the first signaling configuration to the first cluster of ESLs.

Clause 34. The ESL controller of clause 33, wherein the designated ESL corresponds to a cluster head that is tasked with providing feedback to the ESL controller on behalf of the cluster of ESLs in association with measurements associated with the first intra-cluster signaling operation.

Clause 35. The ESL controller of clause 34, further comprising: means for receiving, from the cluster head, measurement feedback associated with the first intra-cluster signaling operation.

Clause 36. The ESL controller of any of clauses 34 to 35, wherein the first cluster of ESLs comprises a first sub-cluster of ESLs and a second sub-cluster of ESLs.

Clause 37. The ESL controller of clause 36, wherein the first signaling configuration configures, during a first time duration, only the first sub-cluster to transmit measurement information associated with the first intra-cluster signaling operation to the cluster head, and wherein the first signaling configuration configures, during a second time duration, only the second sub-cluster to transmit measurement information associated with the first intra-cluster signaling operation to the cluster head.

Clause 38. The ESL controller of any of clauses 33 to 37, wherein the transmission power configuration allocates transmission power in proportion to the distances between the respective ESLs of the first cluster of ESLs and the designated ESL, or wherein the transmission power configuration is based on historical measurement feedback from one or more historical intra-cluster signaling operations associated with the first cluster of ESLs, or wherein the transmission power configuration comprises a set of transmission power values associated with a respective set of the ESLs in the first cluster of ESLs, or wherein the transmission power configuration comprises a decay function that reduces transmission power over time, or wherein the transmission power configuration reduces transmission power from at least one ESL in the first cluster of ESLs relative to at least one corresponding transmission power from the at least one ESL associated with the one or more historical intra-cluster signaling operations based on the historical measurement feedback, or any combination thereof.

Clause 39. The ESL controller of any of clauses 33 to 38, further comprising: means for determining a second signaling configuration associated with a second intra-cluster signaling operation between ESLs of a second cluster of ESLs deployed in the facility, wherein the second signaling configuration comprises a respective T-F resource configuration that is non-overlapping with respect to the T-F resource configuration; and means for transmitting the second signaling configuration to the second cluster of ESLs.

Clause 40. The ESL controller of any of clauses 33 to 39, wherein the first signaling configuration is transmitted to the cluster of ESLs via a payload element of an ESL controller beacon message.

Clause 41. An electronic shelf label (ESL), comprising: means for receiving, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and means for performing an intra-cluster signaling operation in accordance with the signaling configuration.

Clause 42. The ESL of clause 41, means for receiving, during a time duration for which the ESL is the designated ESL, measurement information associated with the intra-cluster signaling operation; and means for transmitting, to the ESL controller, measurement feedback based on the measurement information from one or more other ESLs, measurement information that is based on measurements performed by the ESL in association with the intra-cluster signaling operation, or a combination thereof.

Clause 43. The ESL of any of clauses 41 to 42, further comprising: means for performing, during a time duration for which another ESL is the designated ESL, the intra-cluster signaling operation; and means for transmitting, to the designated ESL, measurement information associated with the intra-cluster signaling operation.

Clause 44. The ESL of any of clauses 41 to 43, wherein the designated ESL corresponds to a cluster head that is tasked with providing feedback to the ESL controller on behalf of the cluster of ESLs in association with measurements associated with the intra-cluster signaling operation.

Clause 45. The ESL of clause 44, wherein the cluster of ESLs comprises a first sub-cluster of ESLs and a second sub-cluster of ESLs.

Clause 46. The ESL of clause 45, wherein the signaling configuration configures, during a first time duration, only the first sub-cluster to transmit measurement information associated with the intra-cluster signaling operation to the cluster head, and wherein the signaling configuration configures, during a second time duration, only the second sub-cluster to transmit measurement information associated with the intra-cluster signaling operation to the cluster head.

Clause 47. The ESL of any of clauses 41 to 46, wherein the transmission power configuration allocates transmission power in proportion to the distances between the respective ESLs of the cluster of ESLs and the designated ESL, or wherein the transmission power configuration is based on historical measurement feedback from one or more historical intra-cluster signaling operations associated with the cluster of ESLs, or wherein the transmission power configuration comprises a set of transmission power values associated with a respective set of the ESLs in the cluster of ESLs, or wherein the transmission power configuration comprises a decay function that reduces transmission power over time, or wherein the transmission power configuration reduces transmission power from at least one ESL in the cluster of ESLs relative to at least one corresponding transmission power from the at least one ESL associated with the one or more historical intra-cluster signaling operations based on the historical measurement feedback, or any combination thereof.

Clause 48. The ESL of any of clauses 41 to 47, wherein the signaling configuration is received via a payload element of an ESL controller beacon message.

Clause 49. A non-transitory computer-readable medium storing computer-executable instructions that, when executed by an electronic shelf label (ESL) controller, cause the ESL controller to: determine a first signaling configuration associated with a first intra-cluster signaling operation between ESLs of a first cluster of ESLs deployed in a facility, wherein the first cluster of ESLs corresponds to a subset of ESLs deployed in the facility, wherein the first signaling configuration comprises a time-frequency (T-F) resource configuration, and wherein the first signaling configuration comprises a transmission power configuration that configures intra-cluster transmission power based on distances between respective ESLs of the first cluster of ESLs and a designated ESL of the first cluster of ESLs; and transmit the first signaling configuration to the first cluster of ESLs.

Clause 50. The non-transitory computer-readable medium of clause 49, wherein the designated ESL corresponds to a cluster head that is tasked with providing feedback to the ESL controller on behalf of the cluster of ESLs in association with measurements associated with the first intra-cluster signaling operation.

Clause 51. The non-transitory computer-readable medium of clause 50, further comprising computer-executable instructions that, when executed by the ESL controller, cause the ESL controller to: receive, from the cluster head, measurement feedback associated with the first intra-cluster signaling operation.

Clause 52. The non-transitory computer-readable medium of any of clauses 50 to 51, wherein the first cluster of ESLs comprises a first sub-cluster of ESLs and a second sub-cluster of ESLs.

Clause 53. The non-transitory computer-readable medium of clause 52, wherein the first signaling configuration configures, during a first time duration, only the first sub-cluster to transmit measurement information associated with the first intra-cluster signaling operation to the cluster head, and wherein the first signaling configuration configures, during a second time duration, only the second sub-cluster to transmit measurement information associated with the first intra-cluster signaling operation to the cluster head.

Clause 54. The non-transitory computer-readable medium of any of clauses 49 to 53, wherein the transmission power configuration allocates transmission power in proportion to the distances between the respective ESLs of the first cluster of ESLs and the designated ESL, or wherein the transmission power configuration is based on historical measurement feedback from one or more historical intra-cluster signaling operations associated with the first cluster of ESLs, or wherein the transmission power configuration comprises a set of transmission power values associated with a respective set of the ESLs in the first cluster of ESLs, or wherein the transmission power configuration comprises a decay function that reduces transmission power over time, or wherein the transmission power configuration reduces transmission power from at least one ESL in the first cluster of ESLs relative to at least one corresponding transmission power from the at least one ESL associated with the one or more historical intra-cluster signaling operations based on the historical measurement feedback, or any combination thereof.

Clause 55. The non-transitory computer-readable medium of any of clauses 49 to 54, further comprising computer-executable instructions that, when executed by the ESL controller, cause the ESL controller to: determine a second signaling configuration associated with a second intra-cluster signaling operation between ESLs of a second cluster of ESLs deployed in the facility, wherein the second signaling configuration comprises a respective T-F resource configuration that is non-overlapping with respect to the T-F resource configuration; and transmit the second signaling configuration to the second cluster of ESLs.

Clause 56. The non-transitory computer-readable medium of any of clauses 49 to 55, wherein the first signaling configuration is transmitted to the cluster of ESLs via a payload element of an ESL controller beacon message.

Clause 57. A non-transitory computer-readable medium storing computer-executable instructions that, when executed by an electronic shelf label (ESL) controller, cause the ESL controller to: receive, from an ESL controller, a signaling configuration associated with an intra-cluster signaling operation between ESLs of a cluster of ESLs deployed in a facility, wherein the cluster of ESLs corresponds to a subset of ESLs deployed in the facility, wherein the signaling configuration comprises a time-frequency (T-F) resource configuration, and wherein the signaling configuration comprises a transmission power configuration that configures intra-cluster transmission power based on distances between respective ESLs of the cluster of ESLs and a designated ESL of the cluster of ESLs; and perform an intra-cluster signaling operation in accordance with the signaling configuration.

Clause 58. The non-transitory computer-readable medium of clause 57, receive, during a time duration for which the ESL is the designated ESL, measurement information associated with the intra-cluster signaling operation; and transmit, to the ESL controller, measurement feedback based on the measurement information from one or more other ESLs, measurement information that is based on measurements performed by the ESL in association with the intra-cluster signaling operation, or a combination thereof.

Clause 59. The non-transitory computer-readable medium of any of clauses 57 to 58, further comprising computer-executable instructions that, when executed by the ESL controller, cause the ESL controller to: perform, during a time duration for which another ESL is the designated ESL, the intra-cluster signaling operation; and transmit, to the designated ESL, measurement information associated with the intra-cluster signaling operation.

Clause 60. The non-transitory computer-readable medium of any of clauses 57 to 59, wherein the designated ESL corresponds to a cluster head that is tasked with providing feedback to the ESL controller on behalf of the cluster of ESLs in association with measurements associated with the intra-cluster signaling operation.

Clause 61. The non-transitory computer-readable medium of clause 60, wherein the cluster of ESLs comprises a first sub-cluster of ESLs and a second sub-cluster of ESLs.

Clause 62. The non-transitory computer-readable medium of clause 61, wherein the signaling configuration configures, during a first time duration, only the first sub-cluster to transmit measurement information associated with the intra-cluster signaling operation to the cluster head, and wherein the signaling configuration configures, during a second time duration, only the second sub-cluster to transmit measurement information associated with the intra-cluster signaling operation to the cluster head.

Clause 63. The non-transitory computer-readable medium of any of clauses 57 to 62, wherein the transmission power configuration allocates transmission power in proportion to the distances between the respective ESLs of the cluster of ESLs and the designated ESL, or wherein the transmission power configuration is based on historical measurement feedback from one or more historical intra-cluster signaling operations associated with the cluster of ESLs, or wherein the transmission power configuration comprises a set of transmission power values associated with a respective set of the ESLs in the cluster of ESLs, or wherein the transmission power configuration comprises a decay function that reduces transmission power over time, or wherein the transmission power configuration reduces transmission power from at least one ESL in the cluster of ESLs relative to at least one corresponding transmission power from the at least one ESL associated with the one or more historical intra-cluster signaling operations based on the historical measurement feedback, or any combination thereof.

Clause 64. The non-transitory computer-readable medium of any of clauses 57 to 63, wherein the signaling configuration is received via a payload element of an ESL controller beacon message.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An electronic shelf label (ESL) controller, comprising:
one or more memories;
one or more transceivers; and
one or more processors communicatively coupled to the one or more memories and the one or more transceivers, wherein the one or more processors, either alone or in combination, are configured to:
determine a first signaling configuration associated with a first intra-cluster signaling operation between ESLs of a first cluster of ESLs deployed in a facility,
wherein the first cluster of ESLs corresponds to a subset of ESLs deployed in the facility,
wherein the first signaling configuration comprises a time-frequency (T-F) resource configuration, and
wherein the first signaling configuration comprises a transmission power configuration that configures intra-cluster transmission power based on distances between respective ESLs of the first cluster of ESLs and a designated ESL of the first cluster of ESLs; and
transmit, via the one or more transceivers, the first signaling configuration to the first cluster of ESLs.

2. The ESL controller of claim 1, wherein the designated ESL corresponds to a cluster head that is tasked with providing feedback to the ESL controller on behalf of the cluster of ESLs in association with measurements associated with the first intra-cluster signaling operation.

3. The ESL controller of claim 2, wherein the one or more processors, either alone or in combination, are further configured to:
receive, via the one or more transceivers, from the cluster head, measurement feedback associated with the first intra-cluster signaling operation.

4. The ESL controller of claim 2, wherein the first cluster of ESLs comprises a first sub-cluster of ESLs and a second sub-cluster of ESLs.

5. The ESL controller of claim 4,
wherein the first signaling configuration configures, during a first time duration, only the first sub-cluster to transmit measurement information associated with the first intra-cluster signaling operation to the cluster head, and
wherein the first signaling configuration configures, during a second time duration, only the second sub-cluster to transmit measurement information associated with the first intra-cluster signaling operation to the cluster head.

6. The ESL controller of claim 1,
wherein the transmission power configuration allocates transmission power in proportion to the distances between the respective ESLs of the first cluster of ESLs and the designated ESL, or
wherein the transmission power configuration is based on historical measurement feedback from one or more historical intra-cluster signaling operations associated with the first cluster of ESLs, or
wherein the transmission power configuration comprises a set of transmission power values associated with a respective set of the ESLs in the first cluster of ESLs, or
wherein the transmission power configuration comprises a decay function that reduces transmission power over time, or
wherein the transmission power configuration reduces transmission power from at least one ESL in the first cluster of ESLs relative to at least one corresponding transmission power from the at least one ESL associated with the one or more historical intra-cluster signaling operations based on the historical measurement feedback, or
any combination thereof.

7. The ESL controller of claim 1, wherein the one or more processors, either alone or in combination, are further configured to:
determine a second signaling configuration associated with a second intra-cluster signaling operation between ESLs of a second cluster of ESLs deployed in the facility,
wherein the second signaling configuration comprises a respective T-F resource configuration that is non-overlapping with respect to the T-F resource configuration; and
transmit, via the one or more transceivers, the second signaling configuration to the second cluster of ESLs.

8. The ESL controller of claim 1, wherein the first signaling configuration is transmitted to the cluster of ESLs via a payload element of an ESL controller beacon message.

9. An electronic shelf label (ESL), comprising:
one or more memories;
one or more transceivers; and
one or more processors communicatively coupled to the one or more memories and the one or more transceivers, wherein the one or more processors, either alone or in combination, are configured to:
receive, via the one or more transceivers, from an ESL controller, a signaling configuration associated with an intra-cluster signaling operation between ESLs of a cluster of ESLs deployed in a facility,
wherein the cluster of ESLs corresponds to a subset of ESLs deployed in the facility,
wherein the signaling configuration comprises a time-frequency (T-F) resource configuration, and
wherein the signaling configuration comprises a transmission power configuration that configures intra-cluster transmission power based on distances between respective ESLs of the cluster of ESLs and a designated ESL of the cluster of ESLs; and
perform an intra-cluster signaling operation in accordance with the signaling configuration.

10. The ESL of claim 9,
receive, via the one or more transceivers, during a time duration for which the ESL is the designated ESL, measurement information associated with the intra-cluster signaling operation; and
transmit, via the one or more transceivers, to the ESL controller, measurement feedback based on the measurement information from one or more other ESLs, measurement information that is based on measurements performed by the ESL in association with the intra-cluster signaling operation, or a combination thereof.

11. The ESL of claim 9, wherein the one or more processors, either alone or in combination, are further configured to:
perform during a time duration for which another ESL is the designated ESL, the intra-cluster signaling operation; and
transmit, via the one or more transceivers, to the designated ESL, measurement information associated with the intra-cluster signaling operation.

12. The ESL of claim 9, wherein the designated ESL corresponds to a cluster head that is tasked with providing feedback to the ESL controller on behalf of the cluster of ESLs in association with measurements associated with the intra-cluster signaling operation.

13. The ESL of claim 12, wherein the cluster of ESLs comprises a first sub-cluster of ESLs and a second sub-cluster of ESLs.

14. The ESL of claim 13,
wherein the signaling configuration configures, during a first time duration, only the first sub-cluster to transmit measurement information associated with the intra-cluster signaling operation to the cluster head, and
wherein the signaling configuration configures, during a second time duration, only the second sub-cluster to transmit measurement information associated with the intra-cluster signaling operation to the cluster head.

15. The ESL of claim 9,
wherein the transmission power configuration allocates transmission power in proportion to the distances between the respective ESLs of the cluster of ESLs and the designated ESL, or
wherein the transmission power configuration is based on historical measurement feedback from one or more historical intra-cluster signaling operations associated with the cluster of ESLs, or
wherein the transmission power configuration comprises a set of transmission power values associated with a respective set of the ESLs in the cluster of ESLs, or
wherein the transmission power configuration comprises a decay function that reduces transmission power over time, or
wherein the transmission power configuration reduces transmission power from at least one ESL in the cluster of ESLs relative to at least one corresponding transmission power from the at least one ESL associated with the one or more historical intra-cluster signaling operations based on the historical measurement feedback, or
any combination thereof.

16. The ESL of claim 9, wherein the signaling configuration is received via a payload element of an ESL controller beacon message.

17. A method performed by an electronic shelf label (ESL) controller, comprising:
determining a first signaling configuration associated with a first intra-cluster signaling operation between ESLs of a first cluster of ESLs deployed in a facility,
wherein the first cluster of ESLs corresponds to a subset of ESLs deployed in the facility,
wherein the first signaling configuration comprises a time-frequency (T-F) resource configuration, and
wherein the first signaling configuration comprises a transmission power configuration that configures intra-cluster transmission power based on distances between respective ESLs of the first cluster of ESLs and a designated ESL of the first cluster of ESLs; and
transmitting the first signaling configuration to the first cluster of ESLs.

18. The method of claim 17, wherein the designated ESL corresponds to a cluster head that is tasked with providing feedback to the ESL controller on behalf of the cluster of ESLs in association with measurements associated with the first intra-cluster signaling operation.

19. The method of claim 18, further comprising:
receiving, from the cluster head, measurement feedback associated with the first intra-cluster signaling operation.

20. The method of claim 18, wherein the first cluster of ESLs comprises a first sub-cluster of ESLs and a second sub-cluster of ESLs.
